(19) United States
(12) Patent Application Publication
(10) Pub. No.: US 2025/0091864 A1
(43) Pub. Date: Mar. 20, 2025

(54) PRODUCING HYDROGEN FROM HYDROGEN SULFIDE

(71) Applicant: Saudi Arabian Oil Company, Dhahran (SA)

(72) Inventors: Ali A. Almofleh, Dhahran (SA); Hassan A. Aljama, Dhahran (SA); Zainab A. Aithan, Dhahran (SA); Guanghui Zhu, Dhahran (SA); Ghulam Shabbir, Dammam (SA); Olatunde O. Onasanya, Dammam (SA)

(21) Appl. No.: 18/469,106

(22) Filed: Sep. 18, 2023

(51) Int. Cl. C01B 17/04; C01B 3/04

(52) U.S. Cl. CPC C01B 17/0447; C01B 3/04; C01B 17/0408; C01B 17/046; C01B 2203/0277; C01B 2203/0838; C01B 2203/0877; C01B 2203/10; C01B 2203/1258; C01B 2210/0014; C01B 2210/0051; C01B 2210/0053; C01B 2210/0064

(57) ABSTRACT

A feed stream including hydrogen sulfide is heated to a preheat temperature. At least a portion of the hydrogen sulfide in the feed stream is converted into hydrogen and sulfur to form a mixed product stream including the hydrogen, the sulfur, and a remaining, unconverted portion of the hydrogen sulfide. The preheat temperature is a temperature that is sufficiently hot to maintain a desired reaction temperature while converting at least the portion of the hydrogen sulfide in the feed stream into hydrogen and sulfur. At least a portion of the mixed product stream is cooled to a specified temperature at which recombination of the hydrogen and the sulfur into hydrogen sulfide is prevented. Cooling at least the portion of the mixed product stream includes condensing at least a portion of the sulfur to form a sulfur stream.

### TECHNICAL FIELD

This disclosure relates to hydrogen production.

### BACKGROUND

Hydrogen sulfide and carbon dioxide exist in various gas streams, including natural gas. Oil or gas that contains significant amounts of sulfur compounds like hydrogen sulfide is considered “sour”, and oil refineries and gas processing plants utilize “sweetening” processes to remove such sulfur compounds. A typical sulfur recovery process includes liquid amine absorption and the Claus process. In liquid amine absorption, hydrogen sulfide and carbon dioxide are selectively removed from gas mixtures, and the hydrogen sulfide and carbon dioxide are flowed to the Claus process, which can convert the hydrogen sulfide into elemental sulfur. The Claus process utilizes oxygen to oxidize hydrogen sulfide into sulfur dioxide and water, and the sulfur dioxide reacts with hydrogen sulfide to produce elemental sulfur and water. The carbon dioxide, on the other hand, is typically released into the atmosphere without further use.

### SUMMARY

This disclosure describes technologies relating to hydrogen production, and in particular, by decomposition of hydrogen sulfide. Certain aspects of the subject matter described can be implemented as a method. A feed stream is heated to a preheat temperature. The feed stream includes hydrogen sulfide. After heating the feed stream, at least a portion of the hydrogen sulfide in the feed stream is converted into hydrogen and sulfur to form a mixed product stream. The mixed product stream includes the hydrogen, the sulfur, and a remaining, unconverted portion of the hydrogen sulfide. The preheat temperature is a temperature that is sufficiently hot to maintain a desired reaction temperature while converting at least the portion of the hydrogen sulfide in the feed stream into hydrogen and sulfur. At least a portion of the mixed product stream is cooled to a specified temperature at which recombination of the hydrogen and the sulfur into hydrogen sulfide is prevented. Cooling at least the portion of the mixed product stream includes condensing at least a portion of the sulfur to form a sulfur stream comprising the sulfur that has condensed from the portion of the mixed product stream.

This, and other aspects, can include one or more of the following features. An acid gas stream can be received by a plurality of pressure swing adsorption beds. The acid gas stream can include carbon dioxide and hydrogen sulfide. At least a portion of the carbon dioxide from the acid gas stream can be separated by the plurality of pressure swing adsorption beds to produce a carbon dioxide stream and the feed stream. The carbon dioxide stream can include the carbon dioxide that has separated from the acid gas stream. The feed stream can include a remaining portion of the acid gas stream. At least the portion of the mixed product stream can be cooled via direct heat exchange with a solid heat transfer medium. The feed stream can be heated via direct heat exchange with the solid heat transfer medium. At least the portion of the mixed product stream can be cooled via direct heat exchange with the solid heat transfer medium within a first vessel. The method can include, after at least the portion of the mixed product stream is cooled via direct heat exchange with the solid heat transfer medium within the first vessel, transporting the solid heat transfer medium from the first vessel to a second vessel. The feed stream can be heated via direct heat exchange with the solid heat transfer medium within the second vessel. The feed stream can be heated via direct heat exchange with a first solid heat transfer medium. At least the portion of the mixed product stream can be cooled via direct heat exchange with a second solid heat transfer medium. After the feed stream is heated via direct heat exchange with the first solid heat transfer medium, and at least the portion of the mixed product stream is cooled via direct heat exchange with the second solid heat transfer medium, the feed stream can be heated via direct heat exchange with the second solid heat transfer medium. After the feed stream is heated via direct heat exchange with the first solid heat transfer medium, and at least the portion of the mixed product stream is cooled via direct heat exchange with the second solid heat transfer medium, at least the portion of the mixed product stream can be cooled via direct heat exchange with the first solid heat transfer medium. The first solid heat transfer medium can be disposed within a first vessel. The second solid heat transfer medium can be disposed within a second vessel. The method can include flowing the feed stream through the first vessel, thereby bringing the feed stream in contact with the first solid heat transfer medium and heating the feed stream. The method can include flowing at least the portion of the mixed product stream through the second vessel, thereby bringing at least the portion of the mixed product stream in contact with the second solid heat transfer medium and cooling at least the portion of the mixed product stream. The method can include, after flowing the feed stream through the first vessel and flowing at least the portion of the mixed product stream through the second vessel, flowing the feed stream through the second vessel, thereby bringing the feed stream in contact with the second solid heat transfer medium and heating the feed stream. The method can include, after flowing the feed stream through the first vessel and flowing at least the portion of the mixed product stream through the second vessel, flowing at least the portion of the mixed product stream through the first vessel, thereby bringing at least the portion of the mixed product stream in contact with the first solid heat transfer medium and cooling at least the portion of the mixed product stream. Cooling at least the portion of the mixed product stream can include mixing the mixed product stream with water or liquefied sulfur. The method can include, after mixing the mixed product stream with water, separating the water from the mixed product stream to produce the sulfur stream, and recycling the separated water back to the mixed product stream.

Certain aspects of the subject matter described can be implemented as a system. The system includes a first heat transfer vessel, a catalytic reactor, and a second heat transfer vessel. The first heat transfer vessel is configured to heat a feed stream to a preheat temperature. The feed stream includes hydrogen sulfide. The catalytic reactor is downstream of the first heat transfer vessel. The catalytic reactor is configured to receive at least a portion of the feed stream from the first heat transfer vessel. The catalytic reactor includes a catalyst. The catalytic reactor is configured to contact the portion of the feed stream with the catalyst. The catalyst is configured to, in response to contact with the portion of the feed stream, convert at least a portion of the hydrogen sulfide in the portion of the feed stream into hydrogen and sulfur to form a mixed product stream. The catalytic reactor is configured to discharge the mixed product stream. The mixed product stream includes the hydrogen, the sulfur, and a remaining, unconverted portion of the hydrogen sulfide. The preheat temperature is a temperature that is sufficiently high to maintain a desired reaction temperature within the catalytic reactor. The second heat transfer vessel is downstream of the catalytic reactor. The second heat transfer vessel is configured to receive the mixed product stream. The second heat transfer vessel is configured to cool the mixed product stream to a specified temperature at which recombination of the hydrogen and the sulfur into hydrogen sulfide is prevented.

This, and other aspects, can include one or more of the following features. The system can include a separation unit upstream of the heater. The separation unit can be configured to receive an acid gas stream comprising carbon dioxide and hydrogen sulfide. The separation unit can include a plurality of pressure swing adsorption beds configured to separate at least a portion of the carbon dioxide from the acid gas stream to produce a carbon dioxide stream and the feed stream. The separation unit can be configured to discharge the carbon dioxide stream and the feed stream. The carbon dioxide stream can include the carbon dioxide that has separated from the acid gas stream. The feed stream can include a remaining portion of the acid gas stream. The second heat transfer vessel can be configured to transfer heat from the mixed product stream to a solid heat transfer medium, thereby heating the solid heat transfer medium and cooling the mixed product stream to the specified temperature. The first heat transfer vessel can be configured to receive the heated solid heat transfer medium from the second heat transfer vessel. The first heat transfer vessel can be configured to transfer heat from the solid heat transfer medium to the feed stream, thereby cooling the solid heat transfer medium and heating the feed stream to the preheat temperature. The second heat transfer vessel can be configured to receive the cooled solid heat transfer medium from the first heat transfer vessel. A first solid heat transfer medium can be disposed within the first heat transfer vessel. A second solid heat transfer medium can be disposed within the second heat transfer vessel. The first heat transfer vessel can be configured to transfer heat from the first solid heat transfer medium to the feed stream, thereby cooling the first solid heat transfer medium and heating the feed stream to the preheat temperature. The second heat transfer vessel can be configured to transfer heat from the mixed product stream to the second solid heat transfer medium, thereby heating the second solid heat transfer medium and cooling the mixed product stream to the specified temperature. The system can include a flow subsystem. The flow subsystem can include a feed inlet flowline connected to the first heat transfer vessel and the second heat transfer vessel. The flow subsystem can include a feed outlet flowline connected to the first heat transfer vessel, the second heat transfer vessel, and the catalytic reactor. The flow subsystem can include a mixed product inlet flowline connected to the first heat transfer vessel, the second heat transfer vessel, and the catalytic reactor. In a first flow configuration, the flow subsystem can be configured to flow the feed stream through the first heat transfer vessel via the feed inlet flowline, thereby bringing the feed stream in contact with the first solid heat transfer medium and heating the feed stream, while preventing the feed stream from flowing to the second heat transfer vessel via the feed inlet flowline. In the first flow configuration, the flow subsystem can be configured to flow the feed stream from the first heat transfer vessel to the catalytic reactor via the feed outlet flowline. In the first flow configuration, the flow subsystem can be configured to flow the mixed product stream from the catalytic reactor through the second heat transfer vessel via the mixed product inlet flowline, thereby bringing the mixed product stream in contact with the second solid heat transfer medium and cooling the mixed product stream, while preventing the mixed product stream from flowing to the first heat transfer vessel via the mixed product inlet flowline. In a second flow configuration, the flow subsystem can be configured to flow the feed stream through the second heat transfer vessel via the feed inlet flowline, thereby bringing the feed stream in contact with the second solid heat transfer medium and heating the feed stream, while preventing the feed stream from flowing to the first heat transfer vessel via the feed inlet flowline. In the second flow configuration, the flow subsystem can be configured to flow the feed stream from the second heat transfer vessel to the catalytic reactor via the feed outlet flowline. In the second flow configuration, the flow subsystem can be configured to flow the mixed product stream from the catalytic reactor through the first heat transfer vessel via the mixed product inlet flowline, thereby bringing the mixed product stream in contact with the first solid heat transfer medium and cooling the mixed product stream, while preventing the mixed product stream from flowing from the catalytic reactor to the second heat transfer vessel via the mixed product inlet flowline. The second heat transfer vessel can be configured to mix the mixed product stream with water or liquefied sulfur to cool the mixed product stream to the specified temperature. The second heat transfer vessel can be configured to condense at least a portion of the sulfur of the mixed product stream. The second heat transfer vessel can be configured to separate a sulfur stream that includes at least a portion of the sulfur that has condensed. The second heat transfer vessel can be configured to separate a hydrogen stream that includes the hydrogen from the mixed product stream. The system can include a water treatment unit downstream of the second heat transfer vessel. The sulfur stream can include the water. The water treatment unit can be configured to separate the water from the sulfur stream. The water treatment unit can be configured to recycle the separated water to the second heat transfer vessel.

The details of one or more implementations of the subject matter of this disclosure are set forth in the accompanying drawings and the description. Other features, aspects, and advantages of the subject matter will become apparent from the description, the drawings, and the claims.

### DESCRIPTION OF DRAWINGS

FIG. 1A is a schematic diagram of an example system for producing hydrogen from hydrogen sulfide that includes two reactor trains.

FIG. 1B is a schematic diagram of an example system for producing hydrogen from hydrogen sulfide that includes three reactor trains.

FIG. 2 is a schematic diagram of an example system for producing hydrogen from hydrogen sulfide that includes two reactor trains and a separation unit.

FIG. 3 is a schematic diagram of an example system for producing hydrogen from hydrogen sulfide that includes a reactor train and multiple separators.

FIG. 4 is a schematic diagram of an example system for producing hydrogen from hydrogen sulfide that includes two reactor trains, a furnace, and a hydrogenation unit.

FIG. 5 is a flow chart of an example method for producing hydrogen from hydrogen sulfide.

FIG. 6 is a graph of the conversion of hydrogen as a function of residence time at various temperatures.

FIG. 7 is a schematic diagram of an example thermo-catalytic reactor for producing hydrogen from hydrogen sulfide.

FIG. 8A is a schematic diagram of an example system for producing hydrogen from hydrogen sulfide that includes a condenser.

FIG. 8B is a schematic diagram of an example system for producing hydrogen from hydrogen sulfide that includes a condenser and a water treatment unit.

FIG. 9A is a schematic diagram of an example system for producing hydrogen from hydrogen sulfide in a first configuration.

FIG. 9B is a schematic diagram of the system of FIG. 9A in a second configuration.

FIG. 10 is a schematic diagram of an example system for producing hydrogen from hydrogen sulfide that includes heat transfer with a solid heat transfer medium.

FIG. 11A is a schematic diagram of an example system for producing hydrogen from hydrogen sulfide that includes a jacketed pipe downstream of a thermo-catalytic reactor.

FIG. 11B is a graph of the outlet temperature of a thermo-catalytic reactor and conversion of hydrogen as a function of pipe length of the jacketed pipe.

FIG. 12 is a schematic diagram of an example system for producing hydrogen from hydrogen sulfide that includes a condenser connected flange-to-flange downstream of a thermo-catalytic reactor.

FIG. 13 is a flow chart of an example method for producing hydrogen from hydrogen sulfide.

### DETAILED DESCRIPTION

This disclosure describes hydrogen production from decomposition of hydrogen sulfide. The process includes a thermo-catalytic reactor that splits hydrogen sulfide into elemental hydrogen and sulfur. The feed stream includes hydrogen sulfide. For example, the feed stream can be an acid gas stream produced as a byproduct from natural gas processing. The catalyst decomposes the hydrogen sulfide into adsorbed hydrogen atoms and adsorbed sulfur atoms, followed by hydrogen and sulfur gas generation by coupling the adsorbed hydrogen atoms and the adsorbed sulfur atoms, respectively. In contrast to other conventional methods for decomposing hydrogen sulfide (such as the Claus process), the proposed process produces hydrogen gas, which can be useful as a fuel or a feedstock in generating other valuable chemical products. The process can include a pre-heating step to counter the endothermic nature of the hydrogen sulfide decomposition reaction(s). The process can include a post-cooling step to condense and separate the sulfur from the gaseous components. The post-cooling step also prevents recombination of the hydrogen and sulfur back into hydrogen sulfide. In some implementations, the thermo-catalytic reactor defines various zones operating at decreasing temperatures. In some implementations, the post-cooling step includes injection of a cold fluid (such as water or liquefied sulfur) to quench the fluid exiting the thermo-catalytic reactor. In some implementations, the post-cooling step includes cooling via heat exchange with a solid material having a large heat capacity. In some cases, the solid material that has been heated can be used to pre-heat the feed stream. In some implementations, the post-cooling step includes cooling via a heat exchanger (for example, a jacketed pipe or flange-to-flange connected condenser) located downstream of the thermo-catalytic reactor.

The subject matter described in this disclosure can be implemented in particular implementations, so as to realize one or more of the following advantages. The hydrogen originating from the hydrogen sulfide is not simply oxidized to produce water (as it does in the Claus process). Instead, the hydrogen originating from the hydrogen sulfide is a source for producing hydrogen gas, which is a valuable product. The systems and methods described here can be implemented to convert hydrogen sulfide into hydrogen and sulfur without producing carbon dioxide and contributing to greenhouse gas emissions. The systems and methods described here can capture carbon dioxide and either convert or sequester the carbon dioxide such that it does not contribute to greenhouse gas emissions. In some implementations, the systems and methods described here can be implemented free of the use of a furnace, in contrast to the conventional Claus process. Such systems and methods described here do not require an additional air feed stream (which can be required for the conventional Claus process) for the oxygen to react with hydrogen sulfide to form sulfur dioxide, and nitrogen would exit the furnace as an inert stream. Because of the absence of nitrogen in such systems and methods described here, the size of equipment (for example, reactors, heaters, and condensers) can be significantly smaller (for example, by about 40%-60%) in comparison to those required for the conventional Claus process, which can result in both capital and operating cost savings. The systems and methods described here can be implemented to reduce the loss of produced hydrogen by rapidly reducing the temperature of the outlet stream from the thermo-catalytic reactor, thereby avoiding recombination of the hydrogen and the sulfur back into hydrogen sulfide and maintaining the overall conversion of hydrogen sulfide into hydrogen and sulfur.

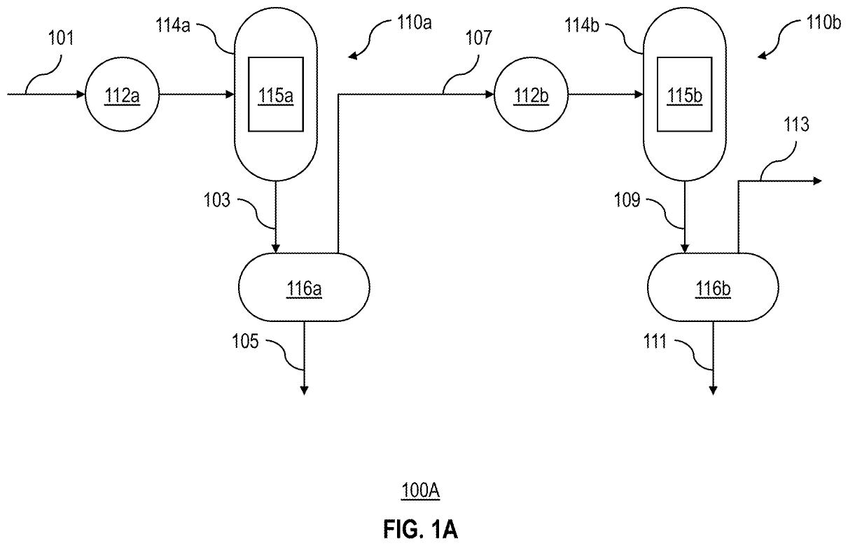

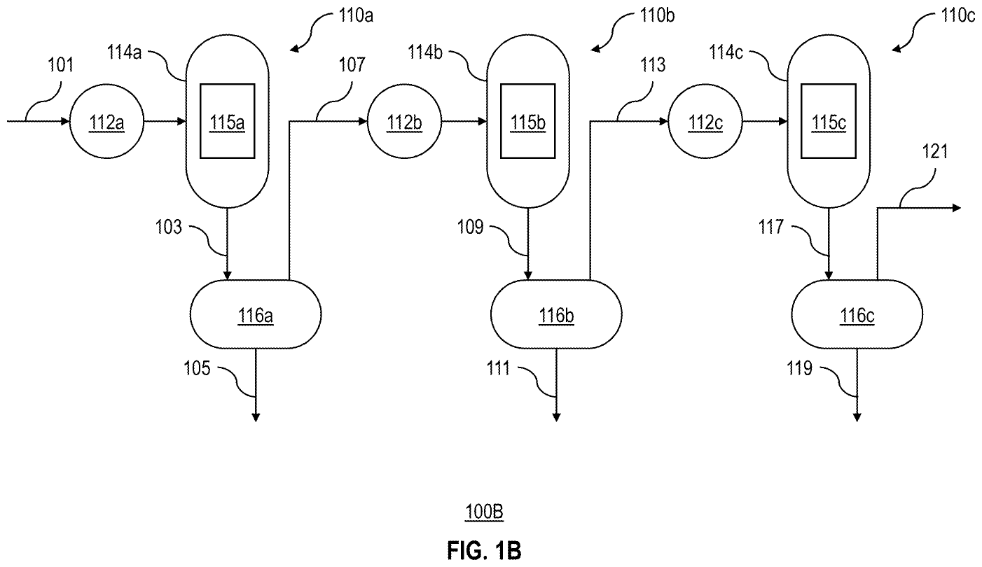

FIG. 1A is a schematic diagram of an example system 100A for producing hydrogen from hydrogen sulfide (H₂S) that includes two reactor trains 110a, 110b. The reactor train 110a includes a heater 112a, a catalytic reactor 114a, and a condenser 116a. The heater 112a is configured to heat a feed stream 101 to a preheat temperature. The feed stream 101 includes hydrogen sulfide. The preheat temperature is a temperature that is sufficiently high to maintain a desired reaction temperature within the catalytic reactor 114a. In some implementations, the preheat temperature is in a range of from in a range of from about 450 degrees Celsius (C) to about 900° C. In some implementations, the desired reaction temperature within the catalytic reactor 114a is in a range of from about 450° C. to about 900° C. The heater 112a can be, for example, a heat exchanger.

In some implementations, the feed stream 101 is (or is derived from) an acid gas resulting from the processing (for example, separation) of natural gas. For example, the feed stream 101 can include carbon dioxide (CO₂), water (H₂O, ammonia (NH₃), a hydrocarbon (such as methane (CH₄)), carbon disulfide (CS₂), carbonyl sulfide (COS), a volatile aromatic hydrocarbon (such as benzene, toluene, ethylbenzene, and xylene or any isomer thereof (BTEX)), or any combination thereof. In some implementations, the feed stream 101 has an H₂S content in a range of from about 20 volume percent (vol. %) to about 95 vol. %. In some implementations, the feed stream 101 has a CO₂ content in a range of from about 5 vol. % to about 75 vol. %. In some implementations, the feed stream 101 has an H₂O content in a range of from 0 vol. % to about 10 vol. % or from about 1 vol. % to about 10 vol. %. In some implementations, the feed stream 101 has an NH₃ content in a range of from 0 vol. % to about 10 vol. %. In some implementations, the feed stream 101 has a CH₄ content in a range of from 0 vol. % to about 5 vol. %. In some implementations, the feed stream 101 has a COS content in a range of from 0 vol. % to about 5 vol. %. In some implementations, the feed stream 101 has a BTEX content in a range of from 0 vol. % to about 5 vol. %. In some implementations, an operating pressure of the feed stream 101 entering the heater 112a is in a range of from about 1 atmosphere to about 5 atmospheres. In some implementations, an operating temperature of the feed stream 101 entering the heater 112a is in a range of from about 20° C. to about 50° C.

The catalytic reactor 114a is downstream of the heater 112a. The catalytic reactor 114a is configured to receive at least a portion of the feed stream 101 from the heater 112a. The catalytic reactor 114a includes a catalyst 115a. The catalytic reactor 114a is configured to contact the portion of the feed stream 101 with the catalyst 115a. The catalyst 115a is configured to, in response to contact with the portion of the feed stream 101, convert at least a portion of the hydrogen sulfide in the portion of the feed stream 101 into hydrogen and sulfur to form a mixed product stream 103. In some implementations, the catalytic reactor 114a is configured to convert at least about 30%, at least about 40%, at least about 50%, at least about 60%, at least about 70%, or at least about 80% of the hydrogen sulfide in the feed stream 101 into hydrogen and sulfur. The catalytic reactor 114a is configured to discharge the mixed product stream 103. The mixed product stream 103 includes the hydrogen produced in the catalytic reactor 114a and the sulfur produced in the catalytic reactor 114a. In some implementations, the mixed product stream 103 includes a remaining, unconverted portion of the hydrogen sulfide from the portion of the feed stream 101.

In some implementations, the catalyst 115a includes a metal sulfide, such as molybdenum sulfide, iron sulfide, or a bi-metal sulfide (such as nickel-doped molybdenum sulfide). In some implementations, the catalyst 115a includes an alloy, such as silver-bismuth or a boron-doped metal (for example, boron-doped palladium). In some implementations, the catalyst 115a includes a metal oxide, such as vanadium oxide or iron oxide.

The condenser 116a is downstream of the catalytic reactor 114a. The condenser 116a is configured to receive at least a portion of the mixed product stream 103. The condenser 116a is configured to cool the portion of the mixed product stream 103 to condense sulfur to form a sulfur stream 105. The condenser 116a is configured to cool the portion of the mixed product stream 103 to a temperature that is cooler than the dew point of sulfur. In some implementations, the condenser 116a is configured to cool the portion of the mixed product stream 103 to a temperature in a range of from about 120° C. to about 200° C. The condenser 116a is configured to discharge the sulfur stream 105. The sulfur stream 105 includes the sulfur that has condensed and separated from the mixed product stream 103. In some implementations, the condenser 116a is configured to discharge an outlet gas stream 107. The outlet gas stream 107 can include a remaining, gaseous portion of the mixed product stream 103 after the sulfur has condensed and been separated. For example, the outlet gas stream 107 includes an unconverted portion of the hydrogen sulfide originating from the feed stream 101. In some implementations, the condenser 116a includes thermally conductive metal channels and/or coils through which cooling/chilling water or a different refrigerant (such as propane) flow. For example, pressurized chilling water flows through the metal channels and/or coils of the condenser 116a. Pressurization of the chilling water can ensure that the chilling water does not vaporize while flowing through the metal channels and/or coils of the condenser 116a, thereby maintaining efficient heat exchange for cooling the mixed product stream 103. In some implementations, the chilling water is pressurized to at least 10 atmospheres. The condenser 116a can include, for example, multiple channels in which the mixed product stream 103 and the cooling/chilling water flow in adjacent channels having a width of 10 millimeters or narrower.

The reactor train 110b is downstream of the reactor train 110a. The reactor train 110b includes a heater 112b, a catalytic reactor 114b, and a condenser 116b. The reactors trains 110a, 110b can be substantially similar. For example, the heaters 112a and 112b of the reactor trains 110a and 110b, respectively, can be substantially similar. As another example, the catalytic reactors 114a and 114b of the reactor trains 110a and 110b, respectively, can be substantially similar. As another example, the catalysts 115a and 115b of the reactor trains 110a and 110b, respectively, can be substantially similar. As another example, the condensers 116a and 116b of the reactor trains 110a and 110b, respectively, can be substantially similar. While similar, the components of the reactor trains 110a, 110b may vary, for example, in size. While similar, the operating parameters (such as temperature and pressure) of the components of the reactor trains 110a, 110b may vary. While similar, the specific compositions of the catalysts 115a, 115b may vary.

The heater 112b is downstream of the condenser 116a. The heater 112b is configured to receive at least a portion of the outlet gas stream 107 from the condenser 116a. The heater 112b is configured to heat at least the portion of the outlet gas stream 107 to a second preheat temperature. The second preheat temperature is a temperature that is sufficiently high to maintain a desired reaction temperature within the catalytic reactor 114b. In some implementations, the second preheat temperature for the heater 112b is substantially similar to the preheat temperature for the heater 112a. In some implementations, the second preheat temperature is in a range of from in a range of from about 450° C. to about 900° C. In some implementations, the desired reaction temperature within the catalytic reactor 114b is in a range of from about 450° C. to about 900° C.

The catalytic reactor 114b is downstream of the heater 112b. The catalytic reactor 114b is configured to receive at least a portion of the outlet gas stream 107 from the heater 112b. The catalytic reactor 114b includes a catalyst 115b. The catalytic reactor 114b is configured to contact the portion of the outlet gas stream 107 with the catalyst 115b. The catalyst 115b is configured to, in response to contact with the portion of the outlet gas stream 107, convert at least a portion of the hydrogen sulfide in the portion of the outlet gas stream 107 into hydrogen and sulfur to form a mixed product stream 109. In some implementations, the catalytic reactor 114b is configured to convert at least about 30%, at least about 40%, at least about 50%, at least about 60%, at least about 70%, or at least about 80% of the hydrogen sulfide in the outlet gas stream 107 into hydrogen and sulfur. The catalytic reactor 114b is configured to discharge the mixed product stream 109. The mixed product stream 109 includes the hydrogen produced in the catalytic reactor 114b and the sulfur produced in the catalytic reactor 114b. In some implementations, the mixed product stream 109 includes a remaining, unconverted portion of the hydrogen sulfide from the portion of the outlet gas stream 107.

The catalyst 115b can have the same composition as or a different composition from the catalyst 115a. In some implementations, the catalyst 115b includes a metal sulfide, such as molybdenum sulfide or iron sulfide. In some implementations, the catalyst 115b includes an alloy, such as silver-bismuth. In some implementations, the catalyst 115b includes a metal oxide, such as vanadium oxide or iron oxide.

The condenser 116b is downstream of the catalytic reactor 114b. The condenser 116b is configured to receive at least a portion of the mixed product stream 109. The condenser 116b is configured to cool the portion of the mixed product stream 109 to condense sulfur to form a sulfur stream 111. The condenser 116b is configured to cool the portion of the mixed product stream 109 to a temperature that is cooler than the dew point of sulfur. In some implementations, the condenser 116b is configured to cool the portion of the mixed product stream 109 to a temperature in a range of from about 120° C. to about 200° C. The condenser 116b is configured to discharge the sulfur stream 111. The sulfur stream 111 includes the sulfur that has condensed and separated from the mixed product stream 109. In some implementations, the condenser 116b is configured to discharge an outlet gas stream 113. The outlet gas stream 113 can include a remaining, gaseous portion of the mixed product stream 109 after the sulfur has condensed and been separated. For example, the outlet gas stream 113 includes an unconverted portion of the hydrogen sulfide originating from the feed stream 101.

The system 100A can, for example, convert at least about 80%, at least about 85%, or at least about 90% of the hydrogen sulfide from the feed stream 101 into hydrogen and sulfide. In some implementations, the outlet gas stream 113 has a hydrogen (H₂) content in a range of from about 15 vol. % to about 90 vol. %. In some implementations, the outlet gas stream 113 has an H₂S content in a range of from 0 vol. % to about 10 vol. %. In some implementations, the outlet gas stream 113 has a CO₂ content in a range of from about 5 vol. % to about 75 vol. %. In some implementations, the outlet gas stream 113 has an H₂O content in a range of from 0 vol. % to about 10 vol. %. In some implementations, the outlet gas stream 113 has an NH₃ content in a range of from 0 vol. % to about 10 vol. %. In some implementations, the outlet gas stream 113 has a CH₄ content in a range of from 0 vol. % to about 5 vol. %. In some implementations, the outlet gas stream 113 has a COS content in a range of from 0 vol. % to about 5 vol. %. In some implementations, the outlet gas stream 113 has a BTEX content in a range of from 0 vol. % to about 5 vol. %. The outlet gas stream 113 can be processed to separate and produce a high purity hydrogen stream. The high purity hydrogen stream can have an H₂ content in a range of from about 98 vol. % to about 100 vol. %. For example, the high purity hydrogen stream can have an H₂ content of at least about 98 vol. %, at least about 99 vol. %, or at least about 99.9 vol. %.

FIG. 1B is a schematic diagram of an example system 100B for producing hydrogen from hydrogen sulfide that includes three reactor trains 110a, 110b, 110c. The reactor train 110c is downstream of the reactor train 110b. The reactor train 110c includes a heater 112c, a catalytic reactor 114c, and a condenser 116c. The reactors trains 110a, 110b, 110c can be substantially similar. For example, the heaters 112a, 112b, and 112c of the reactor trains 110a, 110b, and 110c, respectively, can be substantially similar. As another example, the catalytic reactors 114a, 114b, and 114c of the reactor trains 110a, 110b, and 110c, respectively, can be substantially similar. As another example, the catalysts 115a, 115b, and 115c of the reactor trains 110a, 110b, and 110c, respectively, can be substantially similar. As another example, the condensers 116a, 116b, and 116c of the reactor trains 110a, 110b, and 110c, respectively, can be substantially similar. While similar, the components of the reactor trains 110a, 110b, 110c may vary, for example, in size. While similar, the operating parameters (such as temperature and pressure) of the components of the reactor trains 110a, 110b, 110c may vary. While similar, the specific compositions of the catalysts 115a, 115b, 115c may vary.

The heater 112c is downstream of the condenser 116b. The heater 112c is configured to receive at least a portion of the outlet gas stream 113 from the condenser 116b. The heater 112c is configured to heat at least the portion of the outlet gas stream 113 to a third preheat temperature. The third preheat temperature is a temperature that is sufficiently high to maintain a desired reaction temperature within the catalytic reactor 114c. In some implementations, the third preheat temperature for the heater 112c is substantially similar to the preheat temperature for the heater 112a and/or the second preheat temperature for the heater 112b. In some implementations, the third preheat temperature is in a range of from in a range of from about 450° C. to about 900° C. In some implementations, the desired reaction temperature within the catalytic reactor 114c is in a range of from about 450° C. to about 900° C.

The catalytic reactor 114c is downstream of the heater 112c. The catalytic reactor 114c is configured to receive at least a portion of the outlet gas stream 113 from the heater 112c. The catalytic reactor 114c includes a catalyst 115c. The catalytic reactor 114c is configured to contact the portion of the outlet gas stream 113 with the catalyst 115c. The catalyst 115c is configured to, in response to contact with the portion of the outlet gas stream 113, convert at least a portion of the hydrogen sulfide in the portion of the outlet gas stream 113 into hydrogen and sulfur to form a mixed product stream 117. In some implementations, the catalytic reactor 114c is configured to convert at least about 30%, at least about 40%, at least about 50%, at least about 60%, at least about 70%, or at least about 80% of the hydrogen sulfide in the outlet gas stream 113 into hydrogen and sulfur. The catalytic reactor 114c is configured to discharge the mixed product stream 117. The mixed product stream 117 includes the hydrogen produced in the catalytic reactor 114c and the sulfur produced in the catalytic reactor 114c. In some implementations, the mixed product stream 117 includes a remaining, unconverted portion of the hydrogen sulfide from the portion of the outlet gas stream 113.

The catalyst 115c can have the same composition as or a different composition from the catalyst 115a and/or the catalyst 115b. In some implementations, the catalyst 115c includes a metal sulfide, such as molybdenum sulfide or iron sulfide. In some implementations, the catalyst 115c includes an alloy, such as silver-bismuth. In some implementations, the catalyst 115c includes a metal oxide, such as vanadium oxide or iron oxide.

The condenser 116c is downstream of the catalytic reactor 114c. The condenser 116c is configured to receive at least a portion of the mixed product stream 117. The condenser 116c is configured to cool the portion of the mixed product stream 117 to condense sulfur to form a sulfur stream 119. The condenser 116c is configured to cool the portion of the mixed product stream 117 to a temperature that is cooler than the dew point of sulfur. In some implementations, the condenser 116c is configured to cool the portion of the mixed product stream 117 to a temperature in a range of from about 120° C. to about 200° C. The condenser 116c is configured to discharge the sulfur stream 119. The sulfur stream 119 includes the sulfur that has condensed and separated from the mixed product stream 117. In some implementations, the condenser 116c is configured to discharge an outlet gas stream 121. The outlet gas stream 121 can include a remaining, gaseous portion of the mixed product stream 117 after the sulfur has condensed and been separated. For example, the outlet gas stream 121 includes an unconverted portion of the hydrogen sulfide originating from the feed stream 101.

The system 100C can, for example, convert at least about 80%, at least about 85%, at least about 90%, or at least about 95% of the hydrogen sulfide from the feed stream 101 into hydrogen and sulfide. In some implementations, the outlet gas stream 121 has a hydrogen (H₂) content in a range of from about 15 vol. % to about 95 vol. %. In some implementations, the outlet gas stream 113 has an H₂S content in a range of from 0 vol. % to about 10 vol. %. In some implementations, the outlet gas stream 121 has a CO₂ content in a range of from about 5 vol. % to about 75 vol. %. In some implementations, the outlet gas stream 121 has an H₂O content in a range of from 0 vol. % to about 10 vol. %. In some implementations, the outlet gas stream 121 has an NH₃ content in a range of from 0 vol. % to about 10 vol. %. In some implementations, the outlet gas stream 121 has a CH₄ content in a range of from 0 vol. % to about 5 vol. %. In some implementations, the outlet gas stream 121 has a COS content in a range of from 0 vol. % to about 5 vol. %. In some implementations, the outlet gas stream 121 has a BTEX content in a range of from 0 vol. % to about 5 vol. %. The outlet gas stream 121 can be processed to separate and produce a high purity hydrogen stream. The high purity hydrogen stream can have an H₂ content in a range of from about 98 vol. % to about 100 vol. %. For example, the high purity hydrogen stream can have an H₂ content of at least about 98 vol. %, at least about 99 vol. %, or at least about 99.9 vol. %.

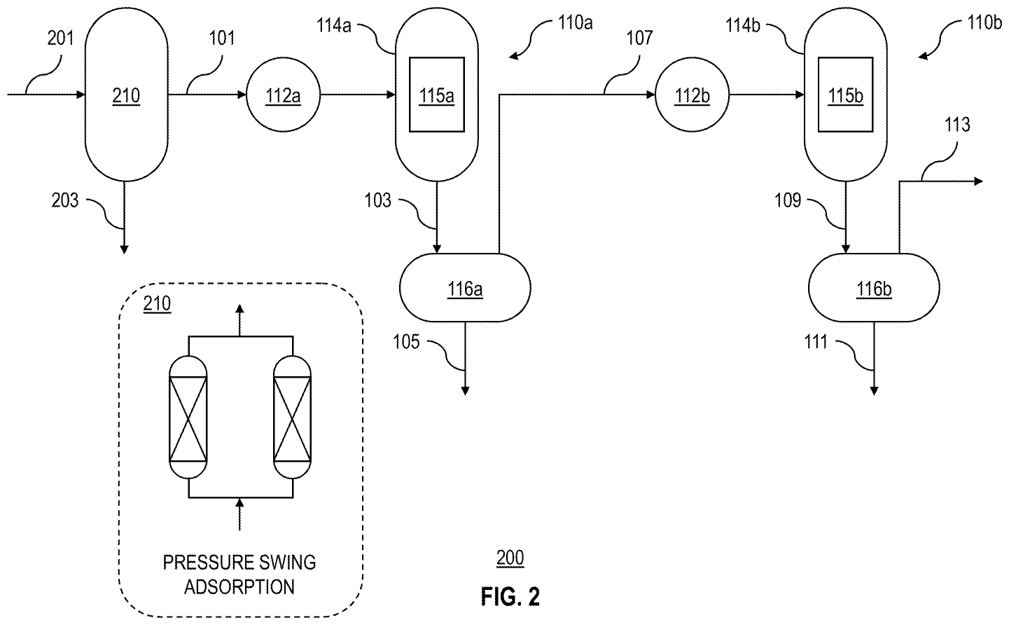

FIG. 2 is a schematic diagram of an example system 200 for producing hydrogen from hydrogen sulfide that includes two reactor trains 110a, 110b and a separation unit 210 that is upstream of the reactor trains 110a, 110b. The separation unit 210 is upstream of the heater 112a. The separation unit 210 is configured to receive an acid gas stream 201. The acid gas stream 201 includes carbon dioxide and hydrogen sulfide. The acid gas stream 210 can, for example, be a byproduct from natural gas processing. The separation unit 210 includes pressure swing adsorption beds 210a, 210b. The pressure swing adsorption beds 210a, 210b are configured to separate at least a portion of the carbon dioxide from the acid gas stream 201 to produce a carbon dioxide stream 203 and the feed stream 101. The carbon dioxide stream 203 includes the carbon dioxide that has separated from the acid gas stream 210. The feed stream 101 includes a remaining portion of the acid gas stream 210 after the carbon dioxide has been separated. The extraction of carbon dioxide from the acid gas stream 201 depends on various factors, such as pressure differential between the beds 210a, 210b and adsorbent material present in the beds 210a, 210b. As shown in FIG. 2, for pressure swing adsorption beds, there are at least two vessels which swing across a range of pressures. During an adsorption process, fluid (for example, the acid gas stream 201) flows through the beds in a first direction, and carbon dioxide is adsorbed to the bed(s) to produce the feed stream 101. During a desorption process, fluid flows through the beds in a second direction, and carbon dioxide is desorbed from the bed(s) to produce the carbon dioxide stream 203. Inclusion of the separation unit 210 can increase a concentration of hydrogen sulfide in the feed stream 101 by removing co-species (such as carbon dioxide). Removal of co-species by the separation unit 210 can result in reduced operating and capital costs by reducing a heating duty of the heaters 112a, 112b, reducing a cooling duty of the condensers 116a, 116b, and reducing equipment sizes for the reactor trains 110a, 110b due to the reduced flow rate of the feed stream 101. Further, removal of co-species by the separation unit 210 can allow for the catalytic reactors 114a, 114b to operate at a cooler temperature (which also relaxes heating and cooling duties of the heaters 112a, 112b and the condensers 116a, 116b, respectively), which can enhance the conversion rate of hydrogen sulfide into hydrogen and sulfur as a result of increasing the partial pressure of hydrogen sulfide.

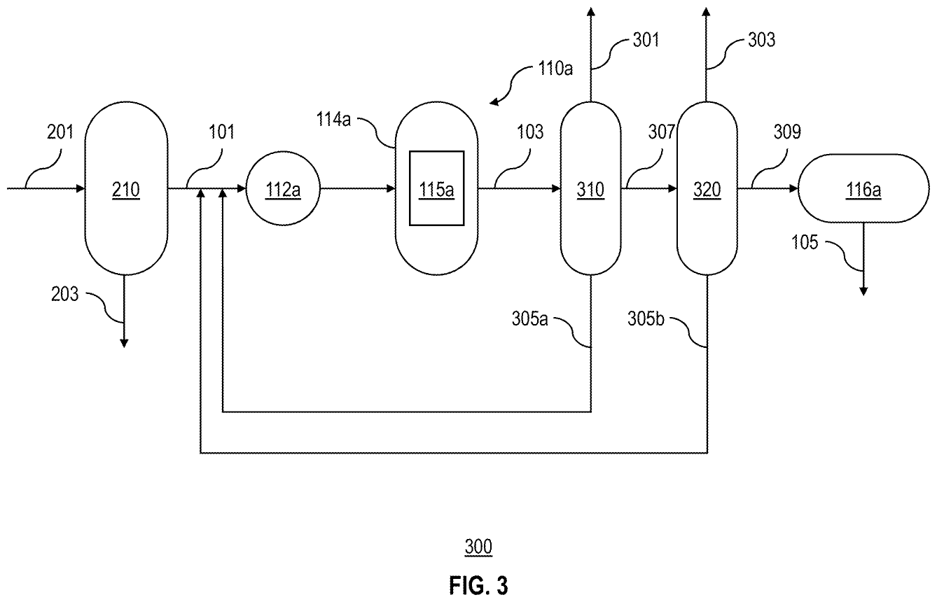

FIG. 3 is a schematic diagram of an example system 300 for producing hydrogen from hydrogen sulfide that includes the reactor train 110a, the separation unit 210, and multiple separators 310, 320. The separators 310, 320 are downstream of the catalytic reactor 114a and upstream of the condenser 116a. The separators 310, 320 are configured to separate at least a portion of carbon dioxide, at least a portion of hydrogen, and at least a portion of the remaining, unconverted hydrogen sulfide from the mixed product stream 103. The separators 310, 320 are configured to discharge a carbon dioxide stream 301, a hydrogen stream 303, a first hydrogen sulfide stream 305a, and a second hydrogen sulfide stream 305b.

The first separator 310 is configured to receive the mixed product stream 103 from the catalytic reactor 114a. In some implementations, the first separator 310 is configured to separate at least a portion of carbon dioxide and at least a portion of the remaining, unconverted hydrogen sulfide from the mixed product stream 103 to produce the carbon dioxide stream 301, the first hydrogen sulfide stream 305a, and a mixed product stream 307. The carbon dioxide stream 301 can include the carbon dioxide that has separated from the mixed product stream 103 by the first separator 310. The first hydrogen sulfide stream 305a can include the hydrogen sulfide that has separated from the mixed product stream 103 by the first separator 310. The mixed product stream 307 can include a remaining portion of the mixed product stream 103 after the carbon dioxide and hydrogen sulfide have been separated by the first separator 310. The first separator 310 can be configured to discharge the carbon dioxide stream 301, the first hydrogen sulfide stream 305a, and the mixed product stream 307. The second separator 320 is downstream of the first separator 310. The second separator 320 is configured to receive the mixed product stream 307 from the first separator 310. In some implementations, the second separator 320 is configured to separate at least a portion of hydrogen and at least a portion of the remaining, unconverted hydrogen sulfide from the mixed product stream 307 to produce the hydrogen stream 303, the second hydrogen sulfide stream 305b, and a mixed product stream 309. The hydrogen stream 303 can include the hydrogen that has separated from the mixed product stream 307 by the second separator 320. The second hydrogen sulfide stream 305b can include the hydrogen sulfide that has separated from the mixed product stream 307 by the second separator 320. The product stream 309 can include a remaining portion of the mixed product stream 307 after the hydrogen and hydrogen sulfide have been separated by the second separator 320. The second separator 320 can be configured to discharge the hydrogen stream 303, the second hydrogen sulfide stream 305b, and the product stream 309. The condenser 116a can be configured to receive the product stream 309 from the second separator 320. The condenser 116a can be configured to cool the product stream 309 to condense sulfur and produce the sulfur stream 105.

In some implementations, the first separator 310 is configured to separate at least a portion of hydrogen and at least a portion of the remaining, unconverted hydrogen sulfide from the mixed product stream 103 to produce the hydrogen stream 303, the first hydrogen sulfide stream 305a, and a mixed product stream 307. The hydrogen stream 303 can include the hydrogen that has separated from the mixed product stream 103 by the first separator 310. The first hydrogen sulfide stream 305a can include the hydrogen sulfide that has separated from the mixed product stream 103 by the first separator 310. The mixed product stream 307 can include a remaining portion of the mixed product stream 103 after the hydrogen and hydrogen sulfide have been separated by the first separator 310. The first separator 310 can be configured to discharge the hydrogen stream 303, the first hydrogen sulfide stream 305a, and the mixed product stream 307. In some implementations, the second separator 320 is configured to separate at least a portion of carbon dioxide and at least a portion of the remaining, unconverted hydrogen sulfide from the mixed product stream 307 to produce the carbon dioxide stream 301, the second hydrogen sulfide stream 305b, and a mixed product stream 309. The carbon dioxide stream 301 can include the carbon dioxide that has separated from the mixed product stream 307 by the second separator 320. The second hydrogen sulfide stream 305b can include the hydrogen sulfide that has separated from the mixed product stream 307 by the second separator 320. The mixed product stream 309 can include a remaining portion of the mixed product stream 307 after the carbon dioxide and hydrogen sulfide have been separated by the second separator 320. The second separator 320 can be configured to discharge the carbon dioxide stream 301, the second hydrogen sulfide stream 305b, and the mixed product stream 309.

In some implementations, the first hydrogen sulfide stream 305a is recycled to the catalytic reactor 114a to increase overall conversion of hydrogen sulfide into hydrogen and sulfur. For example, the heater 112a can be configured to receive and heat the first hydrogen sulfide stream 305a along with the feed stream 101. In some implementations, the second hydrogen sulfide stream 305b is recycled to the catalytic reactor 114a to increase overall conversion of hydrogen sulfide into hydrogen and sulfur. For example, the heater 112a can be configured to receive and heat the second hydrogen sulfide stream 305b along with the feed stream 101. As another example, the heater 112a can be configured to receive and heat the first and second hydrogen sulfide streams 305a, 305b along with the feed stream 101.

By including the separators 310, 320, the system 300 can omit the second reactor train 110b (in comparison to the systems 100A and 100B shown in FIGS. 1A and 1B, respectively). Further, by separating the hydrogen (in the separators 310, 320) prior to condensing the sulfur (in the condenser 116a), the risk of potentially converting the hydrogen and sulfur back into hydrogen sulfide can be mitigated and/or eliminated. Additionally, by recycling the hydrogen sulfide exiting the catalytic reactor 114a back to the catalytic reactor 114a, the overall conversion of hydrogen sulfide into hydrogen and sulfur can be increased in comparison to systems in which hydrogen sulfide is not recycled.

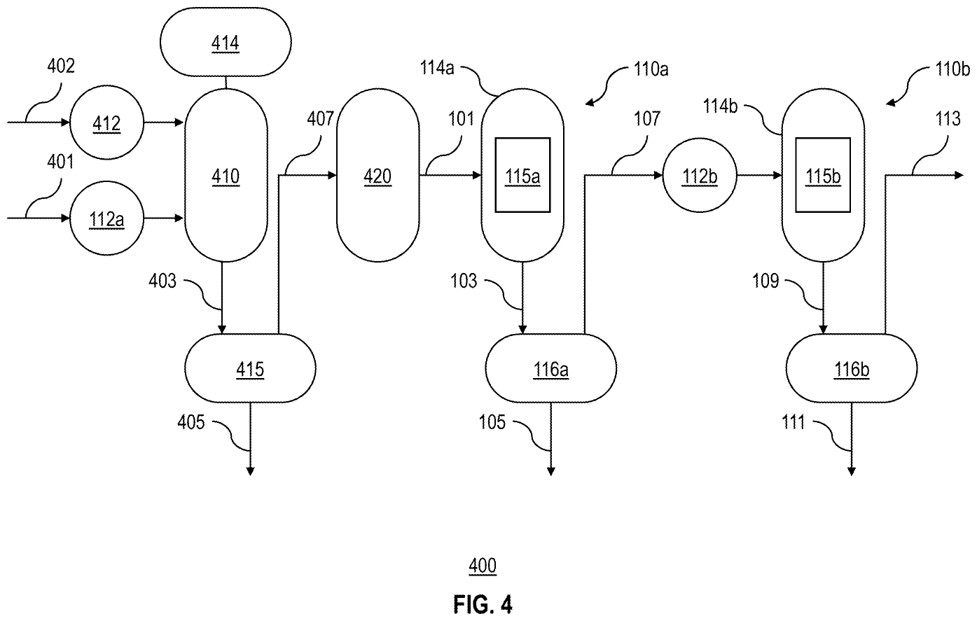

FIG. 4 is a schematic diagram of an example system 400 for producing hydrogen from hydrogen sulfide that includes the reactor trains 110a, 110b, a furnace 410, and a hydrogenation unit 420. The furnace 410 is downstream of the heater 112a and upstream of the catalytic reactor 114a. The hydrogenation unit 320 is downstream of the furnace 410 and upstream of the catalytic reactor 114a. The system 400 includes a condenser 415 downstream of the furnace 410 and upstream of the hydrogenation unit 420.

The heater 112a is configured the receive an acid gas stream 401. The acid gas stream 401 can be substantially similar to the acid gas stream 201 of system 200 shown in FIG. 2. The heater 112a is configured to heat the acid gas stream 401. In some implementations, the heater 112a is configured to heat the acid gas stream 401 to a temperature in a range of from about 220° C. to about 260° C. The furnace 410 is an oxidation reactor configured to convert, in the presence of oxygen, at least a portion of the hydrogen sulfide in the acid gas stream 401 to sulfur and sulfur dioxide to form an oxidized stream 403. The furnace 410 can be, for example, a combustion reactor. In some implementations, the furnace 410 is configured to convert at least about 5%, at least about 10%, at least about 15%, at least about 20%, at least about 25%, or at least about 30% of the hydrogen sulfide in the acid gas stream 401 into sulfur and sulfur dioxide. The sulfur dioxide can also react with the hydrogen sulfide in the acid gas stream 401 to produce additional sulfur. The furnace 410 is configured to discharge the oxidized stream 403. The oxidized stream 403 includes the sulfur and the sulfur dioxide formed in the furnace 410. The oxidized stream 403 includes a remaining portion of the acid gas stream 401 that did not react in the furnace 410. In some implementations, oxygen is provided to the furnace 410.

In some implementations, the oxygen is provided to the furnace 410 via an air stream 402. In some implementations, the air stream 402 is heated by an air heater 412 prior to entering the furnace 410. In some implementations, the air stream 402 is provided at a specified flow rate, such that a molar ratio of oxygen in the air stream 402 to hydrogen sulfide in the acid gas stream 401 is in a range of from about 1:4 to about 3:4. In some implementations, the air heater 412 is configured to heat the air stream 402 to a temperature in a range of from about 220° C. to about 260° C. In some cases, the oxidized stream 403 may include a remaining portion of the air stream 402 that did not react in the furnace 410. In some implementations, the system 400 includes a boiler 414 that is coupled to the furnace 410. The boiler 414 can be configured to receive heat that has been generated by the furnace 410. The boiler 414 can be configured to use the heat from the furnace 410 to evaporate water to produce steam. The steam generated by the boiler 414 can be used, for example, as a utility in a different process or to generate power (for example, by a steam turbine).

The condenser 415 is configured to receive the oxidized stream 403 from the furnace 410. The condenser 415 is configured to cool the oxidized stream 403 to condense sulfur to form a sulfur stream 405. The condenser 415 is configured to cool the oxidized stream 403 to a temperature that is cooler than the dew point of sulfur. In some implementations, the condenser 415 is configured to cool the oxidized stream 403 to a temperature in a range of from about 120° C. to about 200° C. The condenser 415 is configured to discharge the sulfur stream 405. The sulfur stream 405 includes the sulfur that has condensed and separated from the oxidized stream 403. The condenser 415 is configured to discharge a hydrogenation feed stream 407. The hydrogenation feed stream 407 can include a remaining, gaseous portion of the oxidized stream 403 after the sulfur has condensed and been separated.

The hydrogenation unit 420 is configured to receive the hydrogenation feed stream 407. The hydrogenation unit 420 is configured to convert at least a portion of the sulfur dioxide in the hydrogenation feed stream 407 back into hydrogen sulfide to form the feed stream 101. The hydrogenation unit 420 can include a hydrogenation catalyst. The hydrogenation unit 420 can be configured to contact the hydrogenation feed stream 407 with the hydrogenation catalyst. The hydrogenation catalyst can be configured to, in response to contact with the hydrogenation feed stream 407, convert at least a portion of the sulfur dioxide in the hydrogenation feed stream 407 into hydrogen sulfide to form the feed stream 101. In some implementations, the hydrogenation catalyst is a cobalt-molybdenum sulfide catalyst. In some implementations, additional (for example, make up) hydrogen is supplied to the hydrogenation unit 420 for converting the sulfur dioxide into hydrogen sulfide. In some implementations, the hydrogenation unit 420 is configured to convert at least 50%, at least 60%, at least 70%, at least 80%, at least 90%, at least 95%, at least 99%, or at least 99.9% of the sulfur dioxide in the hydrogenation feed stream 407 back into hydrogen sulfide. The feed stream 101 includes the hydrogen sulfide produced in the hydrogenation unit 420. In some implementations, the H₂S content of the feed stream 101 exiting the hydrogenation unit 420 is in a range of from about 10 vol. % to about 70 vol. %. The hydrogenation unit 420 is configured to discharge the feed stream 101. The feed stream 101 can flow from the hydrogenation unit 420 to the catalytic reactor 114a.

By including the furnace 410, contaminants in the acid gas stream 401 can be cracked and/or oxidized prior to converting the hydrogen sulfide into hydrogen and sulfur. The presence of contaminants such as BTEX may hinder the conversion of hydrogen sulfide into hydrogen and sulfur, so cracking and/or oxidizing such contaminants in the furnace 410 can improve overall production efficiency of hydrogen by the system 400. Excess heat generated by the furnace 410 can be recovered and used, for example, to provide steam to other processes or to generate power.

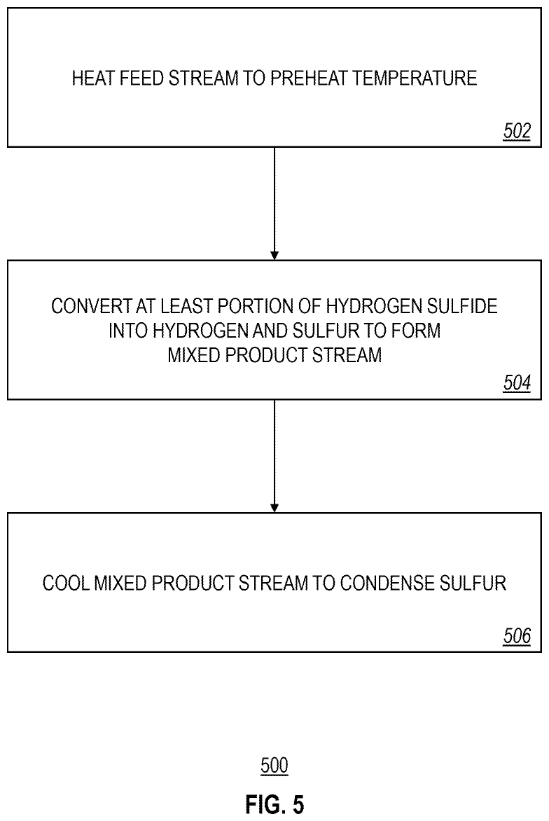

FIG. 5 is a flow chart of an example method 500 for producing hydrogen from hydrogen sulfide. The method 500 can, for example, be implemented by any of the systems 100A, 100B, 200, 300, or 400. At block 502 a feed stream (such as the feed stream 101, the acid gas stream 201, or the acid gas stream 401) is heated to a preheat temperature. The feed stream at block 502 includes hydrogen sulfide. In some implementations, the preheat temperature at block 502 is in a range of from in a range of from about 450° C. to about 900° C. Heating the feed stream at block 502 can, for example, be implemented by the heater 112a. After heating the feed stream at block 502, at least a portion of the hydrogen sulfide in the feed stream is converted into hydrogen and sulfur to form a mixed product stream (such as the mixed product stream 103) at block 504. Converting the hydrogen sulfide into hydrogen and sulfur at block 504 can, for example, be implemented by the catalytic reactor 114a. The mixed product stream formed at block 504 includes the sulfur produced at block 504, the hydrogen produced at block 504, and a remaining portion of the feed stream that did not get converted at block 504 (for example, a remaining, unconverted portion of the hydrogen sulfide from the feed stream). The preheat temperature at block 502 can be a temperature that is sufficiently hot to maintain a desired reaction temperature while converting the hydrogen sulfide into hydrogen and sulfur at block 504. At block 506, at least a portion of the mixed product stream (produced at block 504) is cooled to condense the sulfur to form a sulfur stream (such as the sulfur stream 105). The sulfur stream produced at block 506 includes the sulfur that has condensed and separated from the mixed product stream at block 506. Cooling the mixed product stream at block 506 can, for example, be implemented by the condenser 116a.

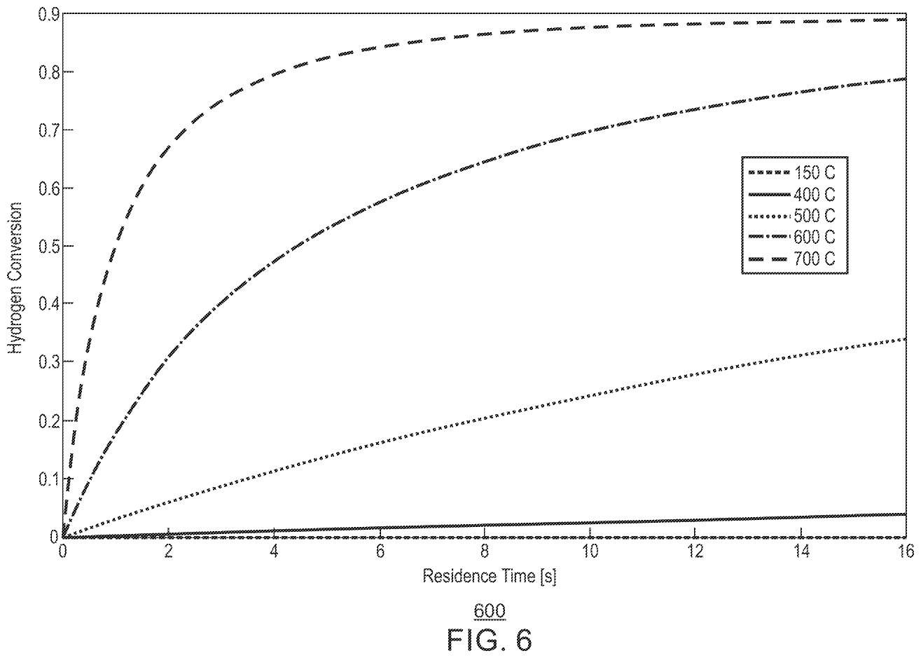

FIG. 6 is a graph 600 of the conversion of hydrogen as a function of residence time (in seconds) at various temperatures (150° C., 400° C., 500° C., 600° C., and 700° C.). The conversions of hydrogen shown in the graph 600 correlate to the conversion of hydrogen back into hydrogen sulfide via combination with sulfur. As shown in graph 600, the rate of conversion of hydrogen to hydrogen sulfide increases with temperature. The conversion of hydrogen to hydrogen sulfide is fastest at 700° C., while the conversion of hydrogen to hydrogen sulfide is slowest at 150° C. In order to reduce the conversion of hydrogen back to hydrogen sulfide via combination with sulfur, the temperature should be decreased. Quicker cooling of the mixed product stream 103 is desirable to reduce and/or eliminate the risk of the hydrogen recombining with the sulfur in the mixed product stream 103 to produce hydrogen sulfide.

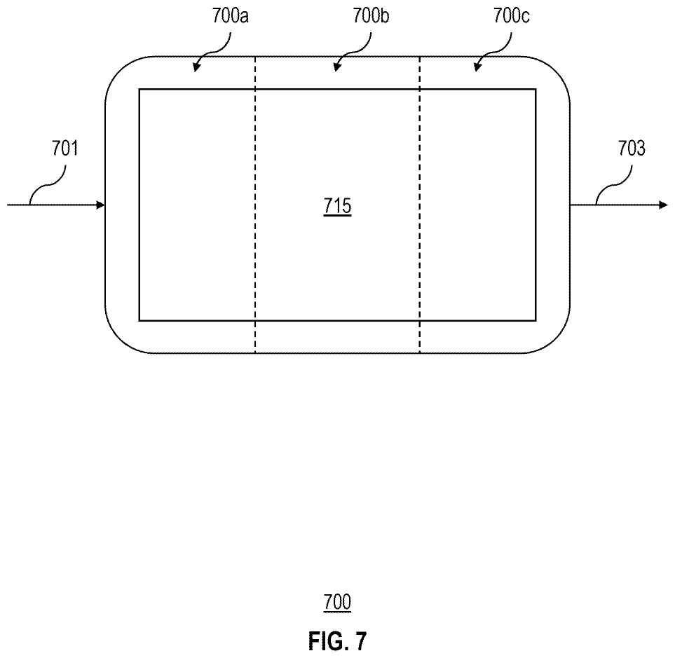

FIG. 7 is a schematic diagram of an example thermo-catalytic reactor 700 for producing hydrogen from hydrogen sulfide. The reactor 700 can be substantially similar to any of the reactors 114a, 114b, or 114c. In some implementations, the reactor 700 can replace any of the thermo-catalytic reactors 114a, 114b, or 114c. The reactor 700 is configured to receive at least a portion of a feed stream 701. The feed stream 701 can be substantially the same as the feed stream 101. The feed stream 701 includes hydrogen sulfide. The reactor 700 includes a catalyst 715. The catalyst 715 can be substantially the same as any of the catalysts 115a, 115b, or 115c. The reactor 700 is configured to contact the portion of the feed stream 701 with the catalyst 715. The catalyst 715 is configured to, in response to contact with the portion of the feed stream 701, convert at least a portion of the hydrogen sulfide in the portion of the feed stream 701 into hydrogen and sulfur to form a mixed product stream 703. The mixed product stream 703 can be substantially the same as the mixed product stream 103. The reactor 700 is configured to discharge the mixed product stream 703. The mixed product stream 703 includes the hydrogen and the sulfur produced in the reactor 700. In some implementations, the mixed product stream 703 includes a remaining, unconverted portion of the hydrogen sulfide from the feed stream 701. The reactor 700 defines multiple zones 700a, 700b, and 700c. Although shown in FIG. 7 as having three zones (700a, 700b, 700c), the reactor 700 may optionally have fewer zones (for example, two zones) or more zones (for example, four, five, or more than five zones). The operating temperatures of the zones (700a, 700b, 700c) can decrease in a general direction of the feed stream 101 through the reactor 700. In some implementations, the operating temperatures of the zones (700a, 700b, 700c) are in a range of from about 400° C. to about 1,200° C., in which the operating temperature of zone 700a is the highest, the operating temperature of zone 700c is lowest, and the operating temperature of zone 700b is intermediate. In some implementations, the first zone 700a is configured to operate at a temperature in a range of from about 800° C. to about 1,200° C., from about 800° C. to about 1,100° C., or from about 800° C. to about 1,000° C. In some implementations, the second zone 700b is configured to operate at a temperature in a range of from about 600° C. to about 800° C. In some implementations, the third zone 700c is configured to operate at a temperature in a range of from about 400° C. to about 600° C. For example, the first zone 700a operates at a temperature of about 900° C., the second zone 700b operates at a temperature of about 700° C., and the third zone 700c operates at a temperature of about 500° C. The decreasing temperatures of the various zones of the reactor 700 can mitigate and/or eliminate the risk of the hydrogen produced within the reactor 700 recombining with sulfur to convert back into hydrogen sulfide. In some implementations, the catalyst 715 spans across the zones (700a, 700b, 700c) of the reactor 700. In some implementations, the reactor 700 includes additional catalysts substantially similar to the catalyst 715. For example, the reactor 700 includes a separate implementation of the catalyst 715 disposed in each of the zones 700a, 700b, and 700c, such that each zone has its own designated catalyst. Although shown in FIG. 7 as a single reactor 700, multiple implementations of the reactor 700 can be applied in series. For example, there can be two, three, four, or five implementations of the reactor 700 in series. As one example, in cases where there are two implementations of the reactor 700 in series, the stream 703 exits the first implementation of the reactor 700 and enters the second implementation of the reactor 700.

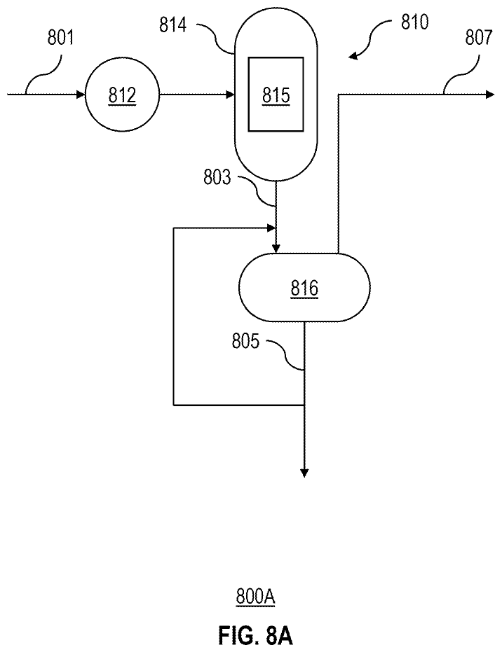

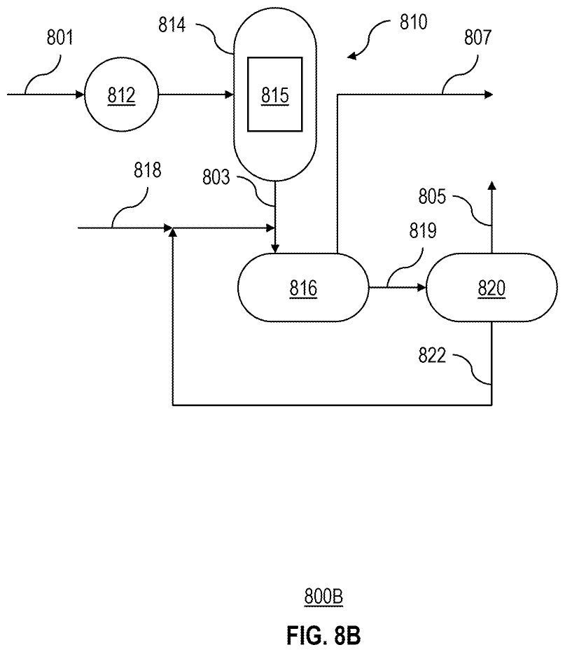

FIG. 8A is a schematic diagram of an example system 800A for producing hydrogen from hydrogen sulfide that includes a condenser 816. The system 800A includes a reactor train 810. The reactor train 810 can be substantially similar to any of the reactor train 110a, 110b, or 110c. The reactor train 810 includes a heater 812, a catalytic reactor 814, and a condenser 816. The heater 812 can be substantially the same as any of the heaters 112a, 112b, or 112c. The catalytic reactor 814 can be substantially the same as any of the reactors 114a, 114b, 114c, or 700. The condenser 816 can be substantially the same as any of the condensers 116a, 116b, 116c, or 415.

The heater 812 is configured to heat a feed stream 801 to a preheat temperature. The feed stream 801 can be substantially the same as the feed stream 101. The feed stream 801 includes hydrogen sulfide. The preheat temperature is a temperature that is sufficiently high to maintain a desired reaction temperature within at least a portion (such as a zone) of the reactor 814. The heater 812 can be, for example, a heat exchanger. The reactor 814 is downstream of the heater 812. The reactor 814 is configured to receive at least a portion of the feed stream 801 from the heater 812. The reactor 814 includes a catalyst 815. The catalyst 815 can be substantially the same as any of the catalysts 115a, 115b, 115c, or 715. The reactor 814 is configured to contact the portion of the feed stream 801 with the catalyst 815. The catalyst 815 is configured to, in response to contact with the portion of the feed stream 801, convert at least a portion of the hydrogen sulfide in the portion of the feed stream 801 into hydrogen and sulfur to form a mixed product stream 803. The mixed product stream 803 can be substantially the same as the mixed product stream 103. The reactor 814 is configured to discharge the mixed product stream 803. The mixed product stream 803 includes the hydrogen and the sulfur produced in the reactor 814. In some implementations, the mixed product stream 803 includes a remaining, unconverted portion of the hydrogen sulfide from the feed stream 801.

The condenser 816 is downstream of the reactor 814. The condenser 816 is configured to receive at least a portion of the mixed product stream 803. The condenser 816 is configured to cool the portion of the mixed product stream 803 to condense sulfur to form a sulfur stream 805. The condenser 816 is configured to cool the portion of the mixed product stream 803 to a temperature that is cooler than the dew point of sulfur. In some implementations, the condenser 816 is configured to cool the portion of the mixed product stream 803 to a temperature in a range of from about 120° C. to about 200° C. The condenser 816 is configured to discharge the sulfur stream 805. The sulfur stream 805 includes the sulfur that has condensed and separated from the mixed product stream 803. In some implementations, the condenser 816 is configured to discharge an outlet gas stream 807. The outlet gas stream 807 can include a remaining, gaseous portion of the mixed product stream 803 after the sulfur has condensed and been separated. For example, the outlet gas stream 807 includes the hydrogen produced by the reactor 814. In some cases, the outlet gas stream 807 includes an unconverted portion of the hydrogen sulfide originating from the feed stream 801. At least a portion of the sulfur stream 805 is recycled and mixed with the mixed product stream 803 exiting the reactor 814. Mixing the portion of the sulfur stream 805 with the mixed product stream 803 provides a quenching effect that quickly cools the mixed product stream 803 prior to entering the condenser 816. Mixing the portion of the sulfur stream 805 with the mixed product stream 803 cools the mixed product stream 803 to a specified temperature at which recombination of the hydrogen and the sulfur into hydrogen sulfide is prevented. Quenching the mixed product stream 803 via mixing with the portion of the sulfur stream 805 can further mitigate and/or eliminate the risk of the hydrogen produced within the reactor 814 recombining with sulfur to convert back into hydrogen sulfide. The specified temperature at which recombination of the hydrogen and the sulfur into hydrogen sulfide is prevented can, for example, be in a range of from about 400° C. to about 500° C.

The configuration shown in FIG. 8A, in which liquid sulfur is recycled and mixed with the mixed product stream 803 exiting the reactor 814 to quench the mixed product stream 803 can be applied to any of the systems 100A, 100B, 200, 300, or 400. For example, at least a portion of the sulfur stream 105 can be recycled and mixed with the mixed product stream 103 exiting the reactor 114a. As another example, at least a portion of the sulfur stream 111 can be recycled and mixed with the mixed product stream 109 exiting the reactor 114b. As another example, at least a portion of the sulfur stream 119 can be recycled and mixed with the mixed product stream 117 exiting the reactor 114c. As another example, at least a portion of the sulfur stream 105 can be recycled and mixed with the mixed product stream 309 exiting the reactor 320. As another example, at least a portion of the sulfur stream 405 can be recycled and mixed with the mixed product stream 403 exiting the reactor 410. Although shown in FIG. 8A as a single reactor train 810, multiple implementations of the reactor train 810 can be applied in series. For example, there can be two, three, four, or five implementations of the reactor train 810 in series. As one example, in cases where there are two implementations of the reactor train 810 in series, the stream 807 exits the first implementation of the reactor train 810 and enters the second implementation of the reactor train 810.

FIG. 8B is a schematic diagram of an example system 800B for producing hydrogen from hydrogen sulfide that includes a condenser 816 and a water treatment unit 820. The system 800B can be substantially similar to the system 800A of FIG. 8A. The system 800B includes the reactor train 810, which includes the heater 812, the catalytic reactor 814, and the condenser 816.

The heater 812 is configured to heat the feed stream 801 to a preheat temperature. The feed stream 801 includes hydrogen sulfide. The preheat temperature is a temperature that is sufficiently high to maintain a desired reaction temperature within at least a portion (such as a zone) of the reactor 814. The reactor 814 is configured to receive at least a portion of the feed stream 801 from the heater 812. The reactor 814 includes a catalyst 815. The catalyst 815 is configured to, in response to contact with the portion of the feed stream 801, convert at least a portion of the hydrogen sulfide in the portion of the feed stream 801 into hydrogen and sulfur to form a mixed product stream 803. The reactor 814 is configured to discharge the mixed product stream 803. The mixed product stream 803 includes the hydrogen and the sulfur produced in the reactor 814. In some implementations, the mixed product stream 803 includes a remaining, unconverted portion of the hydrogen sulfide from the feed stream 801.

Water 818 is mixed with the mixed product stream 803. Mixing the water 818 with the mixed product stream 803 provides a quenching effect that quickly cools the mixed product stream 803 prior to entering the condenser 816. Mixing the water 818 with the mixed product stream 803 cools the mixed product stream 803 to the specified temperature at which recombination of the hydrogen and the sulfur into hydrogen sulfide is prevented. Quenching the mixed product stream 803 via mixing with the water 818 can further mitigate and/or eliminate the risk of the hydrogen produced within the reactor 814 recombining with sulfur to convert back into hydrogen sulfide. The condenser 816 is configured to receive at least a portion of the mixed product stream 803 mixed with the water 818. The condenser 816 is configured to cool the portion of the mixed product stream 803 and water 818 to condense sulfur to form a mixed sulfur stream 819. The condenser 816 is configured to cool the portion of the mixed product stream 803 mixed with the water 818 to a temperature that is cooler than the dew point of sulfur. In some implementations, the condenser 816 is configured to cool the portion of the mixed product stream 803 mixed with the water 818 to a temperature in a range of from about 120° C. to about 200° C. The condenser 816 is configured to discharge the mixed sulfur stream 819. The mixed sulfur stream 189 includes the sulfur that has condensed and separated from the mixed product stream 803, along with water from the water 818. In some implementations, the condenser 816 is configured to discharge an outlet gas stream 807. The outlet gas stream 807 can include a remaining, gaseous portion of the mixed product stream 803 after the sulfur has condensed and been separated. For example, the outlet gas stream 807 includes the hydrogen produced by the reactor 814. In some cases, the outlet gas stream 807 includes an unconverted portion of the hydrogen sulfide originating from the feed stream 801. The mixed sulfur stream 819 is flowed to the water treatment unit 820. The water treatment unit 820 is configured to separate the sulfur from the water, thereby producing a sulfur stream 805 and a water stream 822. At least a portion of the water stream 822 is recycled and mixed with the mixed product stream 803 exiting the reactor 814 (along with the water 818). The configuration shown in FIG. 8B, in which water is recycled and mixed with the mixed product stream 803 exiting the reactor 814 to quench the mixed product stream 803 can be applied to any of the systems 100A, 100B, 200, 300, or 400. Although shown in FIG. 8B as a single reactor train 810, multiple implementations of the reactor train 810 can be applied in series. For example, there can be two, three, four, or five implementations of the reactor train 810 in series. As one example, in cases where there are two implementations of the reactor train 810 in series, the stream 807 exits the first implementation of the reactor train 810 and enters the second implementation of the reactor train 810.

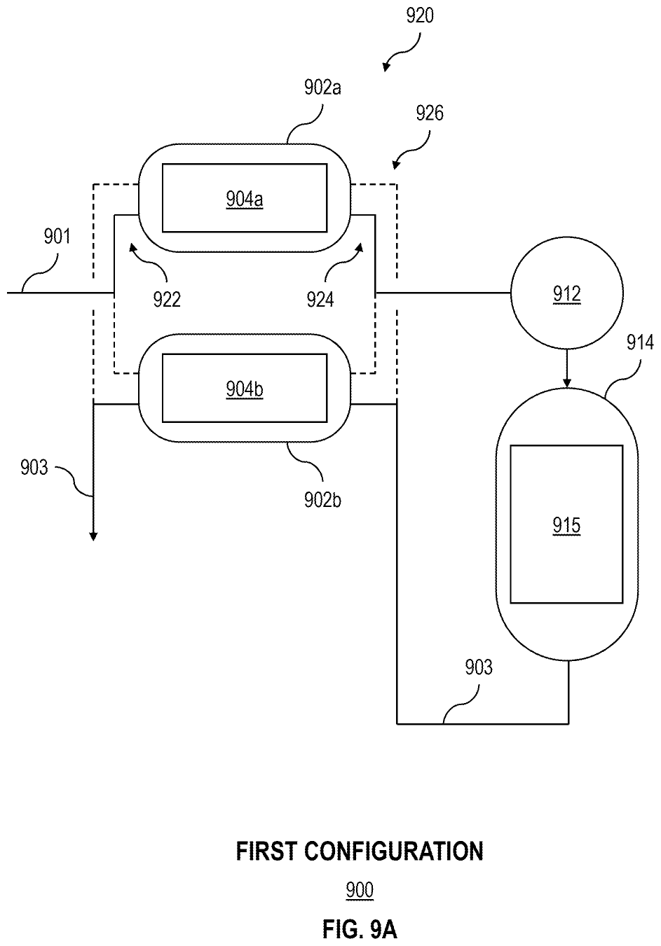

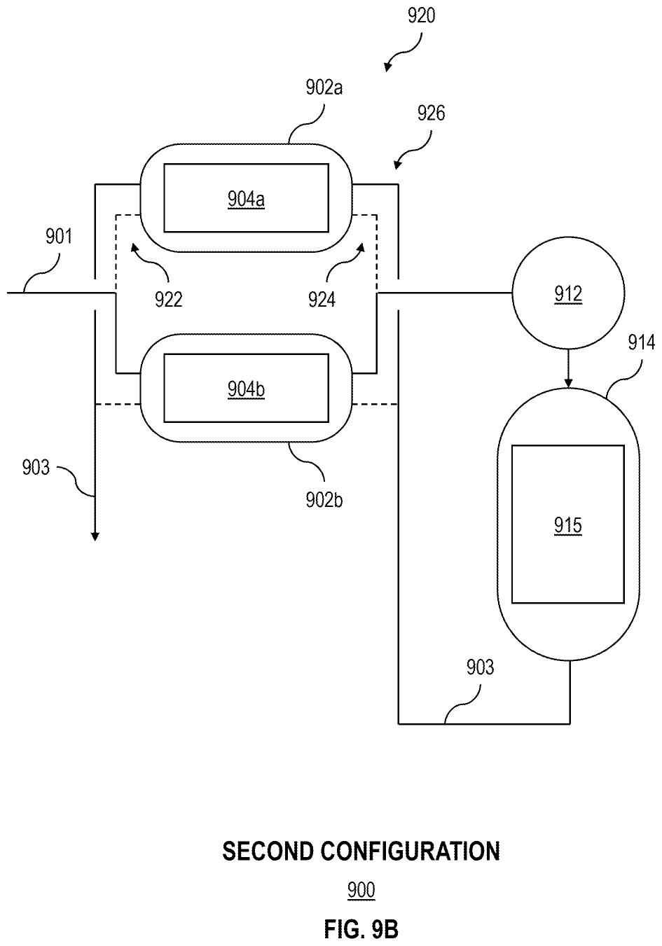

FIG. 9A is a schematic diagram of an example system 900 for producing hydrogen from hydrogen sulfide in a first configuration. The system 900 includes a reactor train 910. The reactor train 910 can be substantially similar to any of the reactor train 110a, 110b, or 110c. The reactor train 910 includes a heater 912 and a catalytic reactor 914. The heater 912 can be substantially the same as any of the heaters 112a, 112b, or 112c. The catalytic reactor 914 can be substantially the same as any of the reactors 114a, 114b, 114c, or 700.

The heater 912 is configured to heat a feed stream 901 to a preheat temperature. The feed stream 901 can be substantially the same as the feed stream 901. The feed stream 901 includes hydrogen sulfide. The preheat temperature is a temperature that is sufficiently high to maintain a desired reaction temperature within at least a portion (such as a zone) of the reactor 914. The heater 912 can be, for example, a heat exchanger. The reactor 914 is downstream of the heater 912. The reactor 914 is configured to receive at least a portion of the feed stream 901 from the heater 912. The reactor 914 includes a catalyst 915. The catalyst 915 can be substantially the same as any of the catalysts 115a, 115b, 115c, or 715. The reactor 914 is configured to contact the portion of the feed stream 901 with the catalyst 915. The catalyst 915 is configured to, in response to contact with the portion of the feed stream 901, convert at least a portion of the hydrogen sulfide in the portion of the feed stream 901 into hydrogen and sulfur to form a mixed product stream 903. The mixed product stream 903 can be substantially the same as the mixed product stream 103. The reactor 914 is configured to discharge the mixed product stream 903. The mixed product stream 903 includes the hydrogen and the sulfur produced in the reactor 914. In some implementations, the mixed product stream 803 includes a remaining, unconverted portion of the hydrogen sulfide from the feed stream 901.

The system 900 includes a pair of heat exchangers 902a, 902b. The heat exchangers 902a, 902b are packed with inert material (904a, 904b, respectively) having a large heat capacity. The inert material (904a, 904b) is chemically inert with respect to the feed stream 901 and the mixed product stream 903, such that when either of the feed stream 901 or the mixed product stream 903 flow through any of the heat exchangers 902a, 902b, the inert material (904a, 904b) packed within the heat exchangers 902a, 902b (respectively) do not react with the feed stream 901 or the mixed product stream 903 and simply transfers heat. The inert material 904a, 904b packed within the heat exchangers 902a, 902b (respectively) can, for example, include ceramics, silicon carbide, zirconia, alumina, magnesia, silica, mixed metal oxides, or any combinations of these.

The system 900 includes a flow subsystem 920. The flow subsystem 920 includes a feed inlet flowline 922, a feed outlet flowline 924, and a mixed product inlet flowline 926. The feed inlet flowline 922 is connected to the heat exchangers 902a, 902b. The feed outlet flowline 924 is connected to the heat exchangers 902a, 902b and the reactor 914. The mixed product inlet flowline 926 is connected to the heat exchangers 902a, 902b and the reactor 914. At any given time, the feed inlet flowline 922 flows the feed stream 901 to either one (not both) of the heat exchangers 902a, 902b. For example, in the first configuration, the feed inlet flowline 922 flows the feed stream 901 to the first heat exchanger 902a. At any given time, the feed outlet flowline 924 flows the feed stream 901 from either one (not both) of the heat exchangers 902a, 902b to the reactor 914. For example, in the first configuration, the feed outlet flowline 922 flows the feed stream 901 from the first heat exchanger 902a to the reactor 914. At any given time, the mixed product inlet flowline 926 flows the mixed product stream 902 from the reactor 914 to either one (not both) of the heat exchangers 902a, 902b. For example, in the first configuration, the mixed product inlet flowline 926 flows the mixed product stream 902 from the reactor 914 to the second heat exchanger 902b.

In the first configuration, the feed stream 901 flows through the first heat exchanger 902a, and heat from the inert material 904a packed within the first heat exchanger 902a is transferred to the feed stream 901. In the first configuration, the first heat exchanger 902a functions as a preheater, in which the feed stream 901 heats up as the inert material 904a cools down. In the first configuration, the feed stream 901 flows from the first heat exchanger 902a to the heater 912. In some cases, the first heat exchanger 902a cooperates with the heater 912 to preheat the feed stream 901 to the preheat temperature. In some cases, the heater 912 may be omitted, the first heat exchanger 902a is configured to heat the feed stream 901 to the preheat temperature, and the feed stream 901 flows from the first heat exchanger 902a to the reactor 914. In the first configuration, the mixed product stream 903 flows from the reactor 914 to the second heat exchanger 902b. In the first configuration, the mixed product stream 903 flows through the second heat exchanger 902b, and heat from the mixed product stream 903 is transferred to the inert material 904b packed within the second heat exchanger 902b. In the first configuration, the second heat exchanger 902b functions as a precooler, in which the mixed product stream 903 cools down, and the inert material 904b heats up. In some implementations, the second heat exchanger 902b is configured, in the first configuration, to cool the mixed product stream 903 to the specified temperature at which recombination of the hydrogen and the sulfur into hydrogen sulfide is prevented. Cooling the mixed product stream 903 by the second heat exchanger 902b in the first configuration can mitigate and/or eliminate the risk of recombination of hydrogen and sulfur back into hydrogen sulfide. In the first configuration, the mixed product stream 903 can flow from the second heat exchanger 902b to a condenser, such as any of the condensers 116a, 116b, 116c, 415, or 816.

FIG. 9B is a schematic diagram of the system 900 in a second configuration. In the second configuration, the feed inlet flowline 922 flows the feed stream 901 to the second heat exchanger 902b. In the second configuration, the feed stream 901 flows through the second heat exchanger 902b, and heat from the inert material 904b packed within the second heat exchanger 902b is transferred to the feed stream 901. In the second configuration, the second heat exchanger 902b functions as a preheater, in which the feed stream 901 heats up as the inert material 904b cools down. In the second configuration, the feed stream 901 flows from the second heat exchanger 902b to the heater 912. In some cases, the second heat exchanger 902b cooperates with the heater 912 to preheat the feed stream 901 to the preheat temperature. In some cases, the heater 912 may be omitted, the second heat exchanger 902b is configured to heat the feed stream 901 to the preheat temperature, and the feed stream 901 flows from the second heat exchanger 902b to the reactor 914. In the second configuration, the feed outlet flowline 922 flows the feed stream 901 from the second heat exchanger 902a to the reactor 914 (or to the heater 912 upstream of the reactor 914). In the second configuration, the mixed product inlet flowline 926 flows the mixed product stream 902 from the reactor 914 to the first heat exchanger 902a. In the second configuration, the mixed product stream 903 flows through the first heat exchanger 902a, and heat from the mixed product stream 903 is transferred to the inert material 904a packed within the first heat exchanger 902a. In the second configuration, the first heat exchanger 902a functions as a precooler, in which the mixed product stream 903 cools down, and the inert material 904a heats up. In some implementations, the first heat exchanger 902a is configured, in the second configuration, to cool the mixed product stream 903 to the specified temperature at which recombination of the hydrogen and the sulfur into hydrogen sulfide is prevented. Cooling the mixed product stream 903 by the first heat exchanger 902a in the second configuration can mitigate and/or eliminate the risk of recombination of hydrogen and sulfur back into hydrogen sulfide. In the second configuration, the mixed product stream 903 can flow from the first heat exchanger 902a to a condenser, such as any of the condensers 116a, 116b, 116c, 415, or 816. The system 900 can switch back and forth between the first configuration and second configuration, as the temperatures of the inert materials 904a, 904b packed within the heat exchangers 902a, 902b (respectively) fluctuate. The switching between the first configuration and second configuration allows the system 900 to operate as a continuous flow system without needing to halt the process between switching. Although shown in FIGS. 9A and 9B as a single reactor train 910, multiple implementations of the reactor train 910 can be applied in series. For example, there can be two, three, four, or five implementations of the reactor train 910 in series. As one example, in cases where there are two implementations of the reactor train 910 in series, the stream 903 exits the first implementation of the reactor train 910 and enters the second implementation of the reactor train 910.

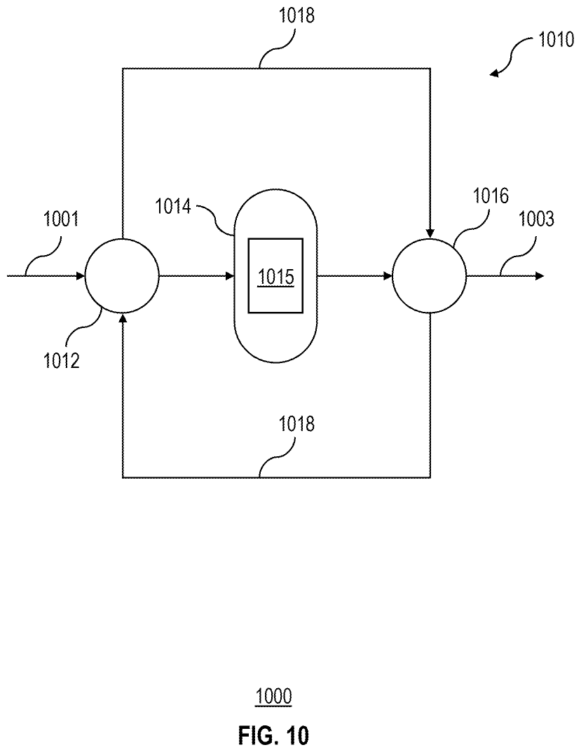

FIG. 10 is a schematic diagram of an example system 1000 for producing hydrogen from hydrogen sulfide that includes heat transfer with a solid heat transfer medium 1018. The system 1000 includes a reactor train 1010. The reactor train 1010 can be substantially similar to any of the reactor train 110a, 110b, or 110c. The reactor train 1010 includes a heater 1012, a catalytic reactor 1014, and a cooler 1016. The heater 1012 can be substantially the same as any of the heaters 112a, 112b, or 112c. The catalytic reactor 1014 can be substantially the same as any of the reactors 114a, 114b, 114c, or 700. The cooler 1016 can be, for example, a heat exchanger. In some cases, the cooler 1016 is substantially the same as any of the heat exchangers 902a or 902b.

The heater 1012 is configured to heat a feed stream 1001 to a preheat temperature. The feed stream 1001 can be substantially the same as the feed stream 101. The feed stream 1001 includes hydrogen sulfide. The preheat temperature is a temperature that is sufficiently high to maintain a desired reaction temperature within at least a portion (such as a zone) of the reactor 1014. The heater 1012 can be, for example, a heat exchanger. The reactor 1014 is downstream of the heater 1012. The reactor 1014 is configured to receive at least a portion of the feed stream 1001 from the heater 1012. The reactor 1014 includes a catalyst 1015. The catalyst 1015 can be substantially the same as any of the catalysts 115a, 115b, 115c, or 715. The reactor 1014 is configured to contact the portion of the feed stream 1001 with the catalyst 1015. The catalyst 1015 is configured to, in response to contact with the portion of the feed stream 1001, convert at least a portion of the hydrogen sulfide in the portion of the feed stream 1001 into hydrogen and sulfur to form a mixed product stream 1003. The mixed product stream 1003 can be substantially the same as the mixed product stream 103. The reactor 1014 is configured to discharge the mixed product stream 1003. The mixed product stream 1003 includes the hydrogen and the sulfur produced in the reactor 1014. In some implementations, the mixed product stream 1003 includes a remaining, unconverted portion of the hydrogen sulfide from the feed stream 1001.

The cooler 1016 is downstream of the reactor 1014. The cooler 1016 is configured to receive at least a portion of the mixed product stream 1003. The cooler 1016 is configured to cool the mixed product stream 1003 to the specified temperature at which recombination of the hydrogen and the sulfur into hydrogen sulfide is prevented. Cooling the mixed product stream 1003 by the cooler 1016 can mitigate and/or eliminate the risk of recombination of hydrogen and sulfur back into hydrogen sulfide. The mixed product stream 1003 can flow from the cooler 1016 to a condenser, such as any of the condensers 116a, 116b, 116c, 415, or 816.

The heater 1012 heats the feed stream 1001 by transferring heat from the solid heat transfer medium 1018 to the feed stream 1001. The cooler 1016 cools the mixed product stream 1003 by transferring heat from the mixed product stream 1003 to the solid heat transfer medium 1018. The solid heat transfer medium 1018 can be continuously circulated from the cooler 1016 to the heater 1012, and back from the heater 1012 to the cooler 1016 to form a continuous heat transfer loop. The solid heat transfer medium 1018 is a solid material that has a high heat capacity. For example, the solid heat transfer medium 1018 can include ceramics, silicon carbide, zirconia, alumina, magnesia, silica, mixed metal oxides, or any combinations of these. In some implementations, the solid heat transfer medium 1018 comes into direct contact with the mixed product stream 1003 within the cooler 1016 and also comes into direct contact with the feed stream 1001 within the heater 1012. In such implementations, the solid heat transfer medium 1018 is an inert material that is chemically inert with respect to the feed stream 1001 and the mixed product stream 1003, such that when the feed stream 1001 flows through the heater 1012 and the mixed product stream 1003 flows through the cooler 1016, the solid heat transfer medium 1018 does not react with the feed stream 1001 nor the mixed product stream 1003 and simply transfers heat. Although shown in FIG. 10 as a single reactor train 1010, multiple implementations of the reactor train 1010 can be applied in series. For example, there can be two, three, four, or five implementations of the reactor train 1010 in series. As one example, in cases where there are two implementations of the reactor train 1010 in series, the stream 1003 exits the first implementation of the reactor train 1010 and enters the second implementation of the reactor train 1010.

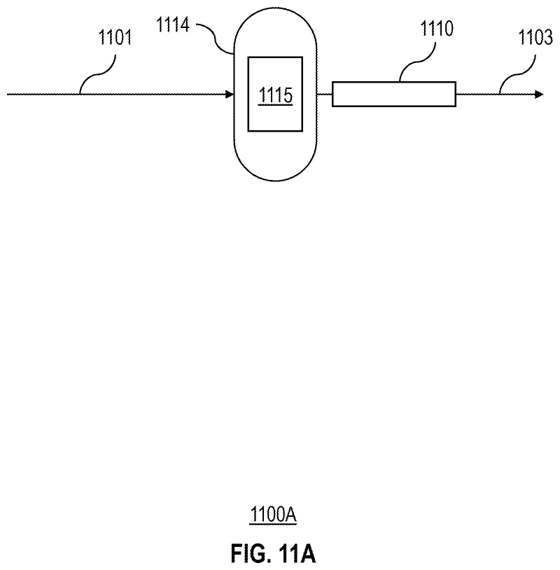

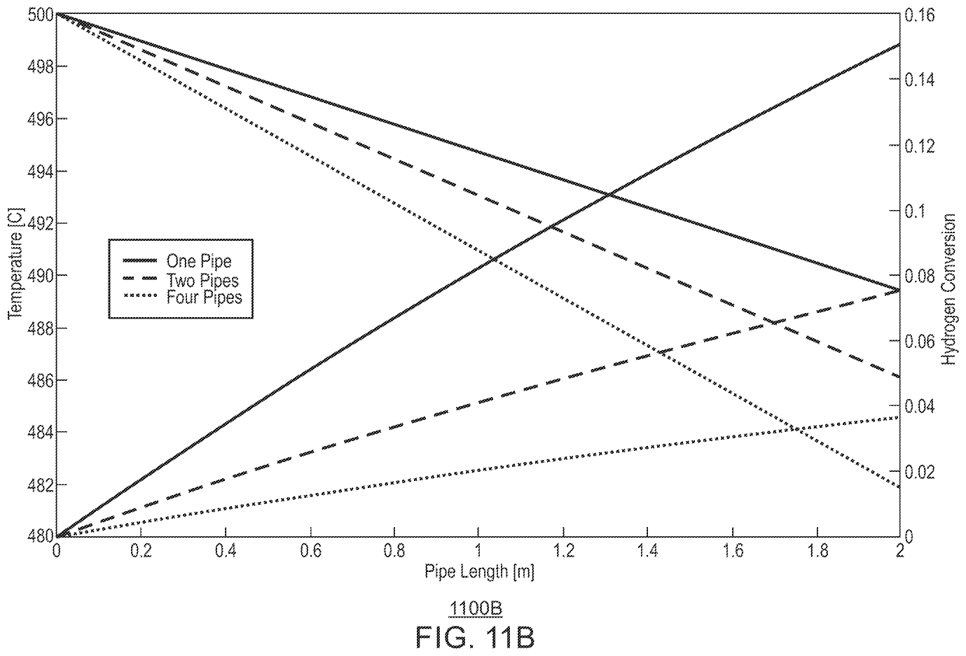

FIG. 11A is a schematic diagram of an example system 1100A for producing hydrogen from hydrogen sulfide that includes a jacketed pipe 1110 downstream of a thermo-catalytic reactor. The system 1100A includes a catalytic reactor 1114. The catalytic reactor 1114 can be substantially the same as any of the reactors 114a, 114b, 114c, or 700. The reactor 1114 is configured to receive a feed stream 1101. The feed stream 1101 can be substantially the same as the feed stream 101. The feed stream 1101 includes hydrogen sulfide. The reactor 1114 includes a catalyst 1115. The catalyst 1115 can be substantially the same as any of the catalysts 115a, 115b, 115c, or 715. The reactor 1114 is configured to contact the feed stream 1101 with the catalyst 1115. The catalyst 1115 is configured to, in response to contact with the portion of the feed stream 1101, convert at least a portion of the hydrogen sulfide in the feed stream 1101 into hydrogen and sulfur to form a mixed product stream 1103. The mixed product stream 1103 can be substantially the same as the mixed product stream 103. The reactor 1114 is configured to discharge the mixed product stream 1103. The mixed product stream 1103 includes the hydrogen and the sulfur produced in the reactor 1114. In some implementations, the mixed product stream 1103 includes a remaining, unconverted portion of the hydrogen sulfide from the feed stream 1101.

The jacketed pipe 1110 is downstream of the reactor 1114. The jacketed pipe 1110 is configured to cool the mixed product stream 1103 to the specified temperature at which recombination of the hydrogen and the sulfur into hydrogen sulfide is prevented. Cooling the mixed product stream 1103 by the jacketed pipe 1110 can mitigate and/or eliminate the risk of recombination of hydrogen and sulfur back into hydrogen sulfide. The mixed product stream 1103 can flow from the jacketed pipe 1110 to a condenser, such as any of the condensers 116a, 116b, 116c, 415, or 816. In some implementations, the mixed product stream 1103 can be split and flowed through multiple implementations of the jacketed pipe 1110 to increase the overall heat transfer area. Including multiple jacketed pipes 1110 can improve cooling efficiency. The configuration shown in FIG. 11A, in which the jacketed pipe 1110 is included downstream of the reactor 1114 to cool the mixed product stream 1103 exiting the reactor 1114 to the specified temperature at which recombination of the hydrogen and the sulfur into hydrogen sulfide is prevented can be applied to any of the systems 100A, 100B, 200, 300, or 400. For example, the jacketed pipe 1110 can be included between the reactor 114a and the condenser 116a. As another example, the jacketed pipe 1110 can be included between the reactor 114b and the condenser 116b. As another example, the jacketed pipe 1110 can be included between the reactor 114c and the condenser 116c. As another example, the jacketed pipe 1110 can be included between the reactor 410 and the condenser 415. Although shown in FIG. 11A as including a single reactor 1114 and a single jacketed pipe 1110, the system 1100A can include multiple implementations of the reactor 1114 and jacketed pipe 1110 can be applied in series. For example, there can be two, three, four, or five implementations of the reactor 1114 and jacketed pipe 1110 in series. As one example, in cases where there are two implementations of the reactor 1114 and jacketed pipe 1110 in series, the stream 1103 exits the first implementation of the jacketed pipe 1110 and enters the second implementation of the reactor 1114.

FIG. 11B is a graph 1100B of the outlet temperature of a thermo-catalytic reactor and conversion of hydrogen as a function of pipe length of the jacketed pipe 1110 and number of jacketed pipes 1110. As shown in graph 1100B, as the number of jacketed pipes 1110 increases (from one to two, and from two to four), the temperature of the mixed product stream 1103 decreases more quickly. Further, as the number of jacketed pipes 1110 increases (from one to two, and from two to four), the conversion rate of hydrogen back into hydrogen sulfide via recombination with sulfur decreases. Thus, increasing the number of jacketed pipes 1110 included downstream of the reactor 1114 can decrease the risk of recombination of hydrogen and sulfur back into hydrogen sulfide.

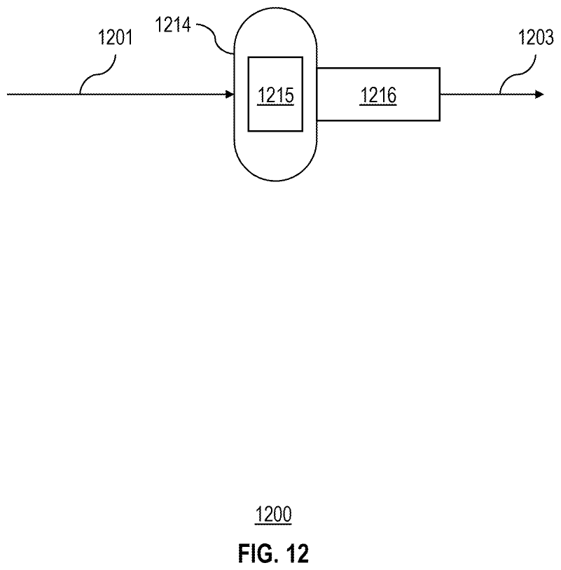

FIG. 12 is a schematic diagram of an example system 1200 for producing hydrogen from hydrogen sulfide that includes a condenser 1216 connected flange-to-flange downstream of a thermo-catalytic reactor 1214. The reactor 1214 can be substantially the same as any of the reactors 114a, 114b, 114c, or 700. The reactor 1214 is configured to receive a feed stream 1201. The feed stream 1201 can be substantially the same as the feed stream 101. The feed stream 1201 includes hydrogen sulfide. The reactor 1214 includes a catalyst 1215. The catalyst 1215 can be substantially the same as any of the catalysts 115a, 115b, 115c, or 715. The reactor 1214 is configured to contact the feed stream 1201 with the catalyst 1215. The catalyst 1215 is configured to, in response to contact with the portion of the feed stream 1201, convert at least a portion of the hydrogen sulfide in the feed stream 1201 into hydrogen and sulfur to form a mixed product stream 1203. The mixed product stream 1203 can be substantially the same as the mixed product stream 103. The mixed product stream 1203 includes the hydrogen and the sulfur produced in the reactor 1114. In some implementations, the mixed product stream 1103 includes a remaining, unconverted portion of the hydrogen sulfide from the feed stream 1101. The reactor 1214 is configured to discharge the mixed product stream 1203 directly to the condenser 1216.

The condenser 1216 can be substantially the same as any of the condensers 116a, 116b, 116c, or 415. The condenser 1216 is configured to cool the mixed product stream 1203 to condense sulfur to form a sulfur stream 1205. The condenser 1216 is configured to cool the portion of the mixed product stream 1203 to a temperature that is cooler than the dew point of sulfur. In some implementations, the condenser 1216 is configured to cool the portion of the mixed product stream 1203 to a temperature in a range of from about 120° C. to about 200° C. The condenser 1216 is configured to discharge the sulfur stream 1205. The sulfur stream 1205 includes the sulfur that has condensed and separated from the mixed product stream 1203. In some implementations, the condenser 1216 is configured to discharge an outlet gas stream 1207. The outlet gas stream 1207 can include a remaining, gaseous portion of the mixed product stream 1203 after the sulfur has condensed and been separated. For example, the outlet gas stream 1207 includes the hydrogen produced by the reactor 1214. In some cases, the outlet gas stream 1207 includes an unconverted portion of the hydrogen sulfide originating from the feed stream 1201. The configuration shown in FIG. 12, in which the condenser 1216 is connected directly downstream to the reactor 1214 via a flange-to-flange connection can be applied to any of the systems 100A, 100B, 200, 300, or 400. For example, the condenser 116a can be connected directly downstream of the reactor 114a via a flange-to-flange connection. As another example, the condenser 116b can be connected directly downstream of the reactor 114b via a flange-to-flange connection. As another example, the condenser 116c can be connected directly downstream of the reactor 114c via a flange-to-flange connection. As another example, the condenser 415 can be connected directly downstream of the reactor 410 via a flange-to-flange connection. Although shown in FIG. 12 as including a single reactor 1214 and a condenser 1216, the system 1200 can include multiple implementations of the reactor 1214 and condenser 1216 can be applied in series. For example, there can be two, three, four, or five implementations of the reactor 1214 and condenser 1216 in series. As one example, in cases where there are two implementations of the reactor 1214 and condenser 1216 in series, the stream 1203 exits the first implementation of the condenser 1216 and enters the second implementation of the reactor 1214.

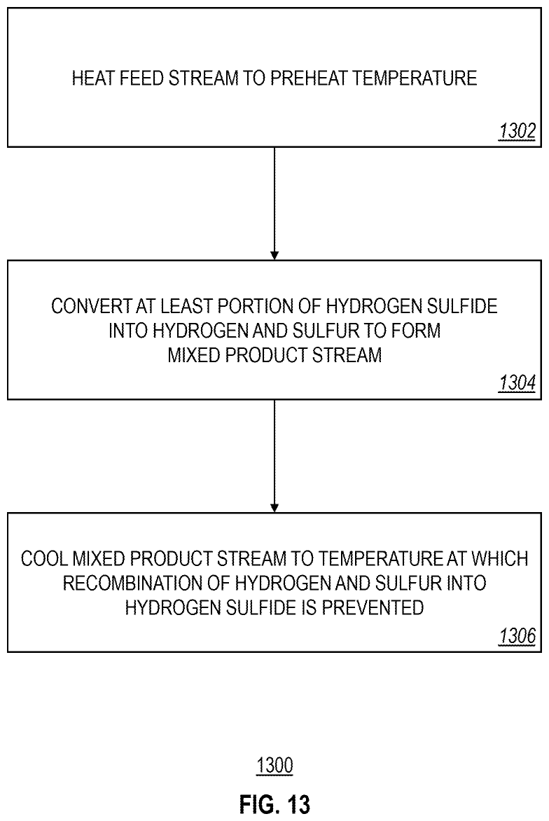

FIG. 13 is a flow chart of an example method 1300 for producing hydrogen from hydrogen sulfide. The method 1300 can, for example, be implemented by any of the systems 100A, 100B, 200, 300, 400, 700, 800A, 800B, 900, 1000, 1100A, or 1200. At block 1302 a feed stream (such as the feed stream 101, 701, 801, 901, 1001, 1101, or 1201, or the acid gas stream 201 or 401) is heated to a preheat temperature. The feed stream at block 1302 includes hydrogen sulfide. In some implementations, the preheat temperature at block 1302 is in a range of from in a range of from about 450° C. to about 900° C. After heating the feed stream at block 1302, at least a portion of the hydrogen sulfide in the feed stream is converted into hydrogen and sulfur to form a mixed product stream (such as the mixed product stream 103) at block 504. Converting the hydrogen sulfide into hydrogen and sulfur at block 1304 can, for example, be implemented by the catalytic reactor 114a, 114b, 114c, 410, 700, 814, 914, 1014, 1114, or 1214. The mixed product stream formed at block 1304 includes the sulfur produced at block 1304, the hydrogen produced at block 1304, and a remaining portion of the feed stream that did not get converted at block 1304 (for example, a remaining, unconverted portion of the hydrogen sulfide from the feed stream). The preheat temperature at block 1302 can be a temperature that is sufficiently hot to maintain a desired reaction temperature while converting the hydrogen sulfide into hydrogen and sulfur at block 1304. At block 1306, at least a portion of the mixed product stream (produced at block 1304) is cooled to a specified temperature at which recombination of the hydrogen and the sulfur into hydrogen sulfide is prevented. Cooling the mixed product stream at block 506 can mitigate and/or eliminate the risk of recombination of hydrogen and sulfur back into hydrogen sulfide and can, for example, be implemented by the condenser 116a, 116b, 116c, 415, 816, 902a, 902b, or 1216, the cooler 1016, or the jacketed pipe 1110. In some implementations, at least a portion of the mixed product stream is cooled at block 1306 to condense the sulfur to form a sulfur stream (such as the sulfur stream 105). The sulfur stream produced at block 1306 includes the sulfur that has condensed and separated from the mixed product stream at block 1306.

### EMBODIMENTS

In an example implementation (or aspect), a method comprises: heating a feed stream comprising hydrogen sulfide to a preheat temperature; after heating the feed stream, converting at least a portion of the hydrogen sulfide in the feed stream into hydrogen and sulfur to form a mixed product stream comprising the hydrogen, the sulfur, and a remaining, unconverted portion of the hydrogen sulfide, wherein the preheat temperature is a temperature that is sufficiently hot to maintain a desired reaction temperature while converting at least the portion of the hydrogen sulfide in the feed stream into hydrogen and sulfur; and cooling at least a portion of the mixed product stream to a specified temperature at which recombination of the hydrogen and the sulfur into hydrogen sulfide is prevented, wherein cooling at least the portion of the mixed product stream comprises condensing at least a portion of the sulfur to form a sulfur stream comprising the sulfur that has condensed from the portion of the mixed product stream.

In an example implementation (or aspect) combinable with any other example implementation (or aspect), the method comprises: receiving, by a plurality of pressure swing adsorption beds, an acid gas stream comprising carbon dioxide and hydrogen sulfide; and separating, by the plurality of pressure swing adsorption beds, at least a portion of the carbon dioxide from the acid gas stream to produce a carbon dioxide stream and the feed stream, the carbon dioxide stream comprising the carbon dioxide that has separated from the acid gas stream, the feed stream comprising a remaining portion of the acid gas stream.

In an example implementation (or aspect) combinable with any other example implementation (or aspect), at least the portion of the mixed product stream is cooled via direct heat exchange with a solid heat transfer medium, and the feed stream is heated via direct heat exchange with the solid heat transfer medium.

In an example implementation (or aspect) combinable with any other example implementation (or aspect), at least the portion of the mixed product stream is cooled via direct heat exchange with the solid heat transfer medium within a first vessel; the method comprises, after at least the portion of the mixed product stream is cooled via direct heat exchange with the solid heat transfer medium within the first vessel, transporting the solid heat transfer medium from the first vessel to a second vessel; and the feed stream is heated via direct heat exchange with the solid heat transfer medium within the second vessel.

In an example implementation (or aspect) combinable with any other example implementation (or aspect), the feed stream is heated via direct heat exchange with a first solid heat transfer medium, and at least the portion of the mixed product stream is cooled via direct heat exchange with a second solid heat transfer medium.

In an example implementation (or aspect) combinable with any other example implementation (or aspect), after the feed stream is heated via direct heat exchange with the first solid heat transfer medium, and at least the portion of the mixed product stream is cooled via direct heat exchange with the second solid heat transfer medium: the feed stream is heated via direct heat exchange with the second solid heat transfer medium; and at least the portion of the mixed product stream is cooled via direct heat exchange with the first solid heat transfer medium.

In an example implementation (or aspect) combinable with any other example implementation (or aspect), the first solid heat transfer medium is disposed within a first vessel; the second solid heat transfer medium is disposed within a second vessel; the method comprises flowing the feed stream through the first vessel, thereby bringing the feed stream in contact with the first solid heat transfer medium and heating the feed stream; and the method comprises flowing at least the portion of the mixed product stream through the second vessel, thereby bringing at least the portion of the mixed product stream in contact with the second solid heat transfer medium and cooling at least the portion of the mixed product stream.

In an example implementation (or aspect) combinable with any other example implementation (or aspect), the method comprises, after flowing the feed stream through the first vessel and flowing at least the portion of the mixed product stream through the second vessel: flowing the feed stream through the second vessel, thereby bringing the feed stream in contact with the second solid heat transfer medium and heating the feed stream; and flowing at least the portion of the mixed product stream through the first vessel, thereby bringing at least the portion of the mixed product stream in contact with the first solid heat transfer medium and cooling at least the portion of the mixed product stream.

In an example implementation (or aspect) combinable with any other example implementation (or aspect), cooling at least the portion of the mixed product stream comprises mixing the mixed product stream with water or liquefied sulfur.

In an example implementation (or aspect) combinable with any other example implementation (or aspect), the method comprises, after mixing the mixed product stream with water, separating the water from the mixed product stream to produce the sulfur stream, and recycling the separated water back to the mixed product stream.

In an example implementation (or aspect), a system comprises: a first heat transfer vessel configured to heat a feed stream to a preheat temperature, the feed stream comprising hydrogen sulfide; a catalytic reactor downstream of the first heat transfer vessel, the catalytic reactor configured to receive at least a portion of the feed stream from the first heat transfer vessel, the catalytic reactor comprising a catalyst, the catalytic reactor configured to contact the portion of the feed stream with the catalyst, the catalyst configured to, in response to contact with the portion of the feed stream, convert at least a portion of the hydrogen sulfide in the portion of the feed stream into hydrogen and sulfur to form a mixed product stream, the catalytic reactor configured to discharge the mixed product stream, the mixed product stream comprising the hydrogen, the sulfur, and a remaining, unconverted portion of the hydrogen sulfide, wherein the preheat temperature is a temperature that is sufficiently high to maintain a desired reaction temperature within the catalytic reactor; and a second heat transfer vessel downstream of the catalytic reactor, the second heat transfer vessel configured to receive the mixed product stream, the second heat transfer vessel configured to cool the mixed product stream to a specified temperature at which recombination of the hydrogen and the sulfur into hydrogen sulfide is prevented.

In an example implementation (or aspect) combinable with any other example implementation (or aspect), the system comprises a separation unit upstream of the heater, the separation unit configured to receive an acid gas stream comprising carbon dioxide and hydrogen sulfide, the separation unit comprising a plurality of pressure swing adsorption beds configured to separate at least a portion of the carbon dioxide from the acid gas stream to produce a carbon dioxide stream and the feed stream, the separation unit configured to discharge the carbon dioxide stream and the feed stream, the carbon dioxide stream comprising the carbon dioxide that has separated from the acid gas stream, the feed stream comprising a remaining portion of the acid gas stream.

In an example implementation (or aspect) combinable with any other example implementation (or aspect), the second heat transfer vessel is configured to transfer heat from the mixed product stream to a solid heat transfer medium, thereby heating the solid heat transfer medium and cooling the mixed product stream to the specified temperature; the first heat transfer vessel is configured to receive the heated solid heat transfer medium from the second heat transfer vessel; the first heat transfer vessel is configured to transfer heat from the solid heat transfer medium to the feed stream, thereby cooling the solid heat transfer medium and heating the feed stream to the preheat temperature; and the second heat transfer vessel is configured to receive the cooled solid heat transfer medium from the first heat transfer vessel.

In an example implementation (or aspect) combinable with any other example implementation (or aspect), a first solid heat transfer medium is disposed within the first heat transfer vessel; a second solid heat transfer medium is disposed within the second heat transfer vessel; the first heat transfer vessel is configured to transfer heat from the first solid heat transfer medium to the feed stream, thereby cooling the first solid heat transfer medium and heating the feed stream to the preheat temperature; and the second heat transfer vessel is configured to transfer heat from the mixed product stream to the second solid heat transfer medium, thereby heating the second solid heat transfer medium and cooling the mixed product stream to the specified temperature.

In an example implementation (or aspect) combinable with any other example implementation (or aspect), the system comprises a flow subsystem comprising: a feed inlet flowline connected to the first heat transfer vessel and the second heat transfer vessel; a feed outlet flowline connected to the first heat transfer vessel, the second heat transfer vessel, and the catalytic reactor; and a mixed product inlet flowline connected to the first heat transfer vessel, the second heat transfer vessel, and the catalytic reactor.

In an example implementation (or aspect) combinable with any other example implementation (or aspect), the flow subsystem is configured to, in a first flow configuration: flow the feed stream through the first heat transfer vessel via the feed inlet flowline, thereby bringing the feed stream in contact with the first solid heat transfer medium and heating the feed stream, while preventing the feed stream from flowing to the second heat transfer vessel via the feed inlet flowline; flow the feed stream from the first heat transfer vessel to the catalytic reactor via the feed outlet flowline; and flow the mixed product stream from the catalytic reactor through the second heat transfer vessel via the mixed product inlet flowline, thereby bringing the mixed product stream in contact with the second solid heat transfer medium and cooling the mixed product stream, while preventing the mixed product stream from flowing to the first heat transfer vessel via the mixed product inlet flowline.

In an example implementation (or aspect) combinable with any other example implementation (or aspect), the flow subsystem is configured to, in a second flow configuration: flow the feed stream through the second heat transfer vessel via the feed inlet flowline, thereby bringing the feed stream in contact with the second solid heat transfer medium and heating the feed stream, while preventing the feed stream from flowing to the first heat transfer vessel via the feed inlet flowline; flow the feed stream from the second heat transfer vessel to the catalytic reactor via the feed outlet flowline; and flowing the mixed product stream from the catalytic reactor through the first heat transfer vessel via the mixed product inlet flowline, thereby bringing the mixed product stream in contact with the first solid heat transfer medium and cooling the mixed product stream, while preventing the mixed product stream from flowing from the catalytic reactor to the second heat transfer vessel via the mixed product inlet flowline.

In an example implementation (or aspect) combinable with any other example implementation (or aspect), the second heat transfer vessel is configured to mix the mixed product stream with water or liquefied sulfur to cool the mixed product stream to the specified temperature.

In an example implementation (or aspect) combinable with any other example implementation (or aspect), the second heat transfer vessel is configured to condense at least a portion of the sulfur of the mixed product stream, wherein the second heat transfer vessel is configured to separate a sulfur stream comprising at least a portion of the sulfur that has condensed, wherein the second heat transfer vessel is configured to separate a hydrogen stream comprising the hydrogen from the mixed product stream.

In an example implementation (or aspect) combinable with any other example implementation (or aspect), the system comprises a water treatment unit downstream of the second heat transfer vessel, wherein the sulfur stream comprises the water, wherein the water treatment unit is configured to separate the water from the sulfur stream, wherein the water treatment unit is configured to recycle the separated water to the second heat transfer vessel.

While this specification contains many specific implementation details, these should not be construed as limitations on the scope of what may be claimed, but rather as descriptions of features that may be specific to particular implementations. Certain features that are described in this specification in the context of separate implementations can also be implemented, in combination, in a single implementation. Conversely, various features that are described in the context of a single implementation can also be implemented in multiple implementations, separately, or in any sub-combination. Moreover, although previously described features may be described as acting in certain combinations and even initially claimed as such, one or more features from a claimed combination can, in some cases, be excised from the combination, and the claimed combination may be directed to a sub-combination or variation of a sub-combination.

As used in this disclosure, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed in this disclosure, and not otherwise defined, is for the purpose of description only and not of limitation. Any use of section headings is intended to aid reading of the document and is not to be interpreted as limiting; information that is relevant to a section heading may occur within or outside of that particular section.

As used in this disclosure, the term “about” or “approximately” can allow for a degree of variability in a value or range, for example, within 10%, within 5%, or within 1% of a stated value or of a stated limit of a range.

As used in this disclosure, the term “substantially” refers to a majority of, or mostly, as in at least about 50%, 60%, 70%, 80%, 90%, 95%, 96%, 97%, 98%, 99%, 99.5%, 99.9%, 99.99%, or at least about 99.999% or more.

Values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “0.1% to about 5%” or “0.1% to 5%” should be interpreted to include about 0.1% to about 5%, as well as the individual values (for example, 1%, 2%, 3%, and 4%) and the sub-ranges (for example, 0.1% to 0.5%, 1.1% to 2.2%, 3.3% to 4.4%) within the indicated range. The statement “X to Y” has the same meaning as “about X to about Y,” unless indicated otherwise. Likewise, the statement “X, Y, or Z” has the same meaning as “about X, about Y, or about Z,” unless indicated otherwise.

Particular implementations of the subject matter have been described. Other implementations, alterations, and permutations of the described implementations are within the scope of the following claims as will be apparent to those skilled in the art. While operations are depicted in the drawings or claims in a particular order, this should not be understood as requiring that such operations be performed in the particular order shown or in sequential order, or that all illustrated operations be performed (some operations may be considered optional), to achieve desirable results. In certain circumstances, multitasking or parallel processing (or a combination of multitasking and parallel processing) may be advantageous and performed as deemed appropriate.

Moreover, the separation or integration of various system modules and components in the previously described implementations should not be understood as requiring such separation or integration in all implementations, and it should be understood that the described components and systems can generally be integrated together or packaged into multiple products.

Accordingly, the previously described example implementations do not define or constrain the present disclosure. Other changes, substitutions, and alterations are also possible without departing from the spirit and scope of the present disclosure.

What is claimed is:

1. A method comprising:
heating a feed stream comprising hydrogen sulfide to a preheat temperature;
after heating the feed stream, converting at least a portion of the hydrogen sulfide in the feed stream into hydrogen and sulfur to form a mixed product stream comprising the hydrogen, the sulfur, and a remaining, unconverted portion of the hydrogen sulfide, wherein the preheat temperature is a temperature that is sufficiently hot to maintain a desired reaction temperature while converting at least the portion of the hydrogen sulfide in the feed stream into hydrogen and sulfur; and
cooling at least a portion of the mixed product stream to a specified temperature at which recombination of the hydrogen and the sulfur into hydrogen sulfide is prevented, wherein cooling at least the portion of the mixed product stream comprises condensing at least a portion of the sulfur to form a sulfur stream comprising the sulfur that has condensed from the portion of the mixed product stream.

2. The method of claim 1, comprising:
receiving, by a plurality of pressure swing adsorption beds, an acid gas stream comprising carbon dioxide and hydrogen sulfide; and
separating, by the plurality of pressure swing adsorption beds, at least a portion of the carbon dioxide from the acid gas stream to produce a carbon dioxide stream and the feed stream, the carbon dioxide stream comprising the carbon dioxide that has separated from the acid gas stream, the feed stream comprising a remaining portion of the acid gas stream.

3. The method of claim 1, wherein at least the portion of the mixed product stream is cooled via direct heat exchange with a solid heat transfer medium, and the feed stream is heated via direct heat exchange with the solid heat transfer medium.

4. The method of claim 3, wherein:
at least the portion of the mixed product stream is cooled via direct heat exchange with the solid heat transfer medium within a first vessel;
the method comprises, after at least the portion of the mixed product stream is cooled via direct heat exchange with the solid heat transfer medium within the first vessel, transporting the solid heat transfer medium from the first vessel to a second vessel; and
the feed stream is heated via direct heat exchange with the solid heat transfer medium within the second vessel.

5. The method of claim 1, wherein the feed stream is heated via direct heat exchange with a first solid heat transfer medium, and at least the portion of the mixed product stream is cooled via direct heat exchange with a second solid heat transfer medium.

6. The method of claim 5, wherein after the feed stream is heated via direct heat exchange with the first solid heat transfer medium, and at least the portion of the mixed product stream is cooled via direct heat exchange with the second solid heat transfer medium:
the feed stream is heated via direct heat exchange with the second solid heat transfer medium; and
at least the portion of the mixed product stream is cooled via direct heat exchange with the first solid heat transfer medium.

7. The method of claim 6, wherein:
the first solid heat transfer medium is disposed within a first vessel;
the second solid heat transfer medium is disposed within a second vessel;
the method comprises flowing the feed stream through the first vessel, thereby bringing the feed stream in contact with the first solid heat transfer medium and heating the feed stream; and
the method comprises flowing at least the portion of the mixed product stream through the second vessel, thereby bringing at least the portion of the mixed product stream in contact with the second solid heat transfer medium and cooling at least the portion of the mixed product stream.

8. The method of claim 7, comprising, after flowing the feed stream through the first vessel and flowing at least the portion of the mixed product stream through the second vessel:
flowing the feed stream through the second vessel, thereby bringing the feed stream in contact with the second solid heat transfer medium and heating the feed stream; and
flowing at least the portion of the mixed product stream through the first vessel, thereby bringing at least the portion of the mixed product stream in contact with the first solid heat transfer medium and cooling at least the portion of the mixed product stream.

9. The method of claim 1, wherein cooling at least the portion of the mixed product stream comprises mixing the mixed product stream with water or liquefied sulfur.

10. The method of claim 9, comprising, after mixing the mixed product stream with water, separating the water from the mixed product stream to produce the sulfur stream, and recycling the separated water back to the mixed product stream.

11. A system comprising:
a first heat transfer vessel configured to heat a feed stream to a preheat temperature, the feed stream comprising hydrogen sulfide;
a catalytic reactor downstream of the first heat transfer vessel, the catalytic reactor configured to receive at least a portion of the feed stream from the first heat transfer vessel, the catalytic reactor comprising a catalyst, the catalytic reactor configured to contact the portion of the feed stream with the catalyst, the catalyst configured to, in response to contact with the portion of the feed stream, convert at least a portion of the hydrogen sulfide in the portion of the feed stream into hydrogen and sulfur to form a mixed product stream, the catalytic reactor configured to discharge the mixed product stream, the mixed product stream comprising the hydrogen, the sulfur, and a remaining, unconverted portion of the hydrogen sulfide, wherein the preheat temperature is a temperature that is sufficiently high to maintain a desired reaction temperature within the catalytic reactor; and
a second heat transfer vessel downstream of the catalytic reactor, the second heat transfer vessel configured to receive the mixed product stream, the second heat transfer vessel configured to cool the mixed product stream to a specified temperature at which recombination of the hydrogen and the sulfur into hydrogen sulfide is prevented.

12. The system of claim 11, comprising a separation unit upstream of the heater, the separation unit configured to receive an acid gas stream comprising carbon dioxide and hydrogen sulfide, the separation unit comprising a plurality of pressure swing adsorption beds configured to separate at least a portion of the carbon dioxide from the acid gas stream to produce a carbon dioxide stream and the feed stream, the separation unit configured to discharge the carbon dioxide stream and the feed stream, the carbon dioxide stream comprising the carbon dioxide that has separated from the acid gas stream, the feed stream comprising a remaining portion of the acid gas stream.

13. The system of claim 11, wherein:
the second heat transfer vessel is configured to transfer heat from the mixed product stream to a solid heat transfer medium, thereby heating the solid heat transfer medium and cooling the mixed product stream to the specified temperature;
the first heat transfer vessel is configured to receive the heated solid heat transfer medium from the second heat transfer vessel;
the first heat transfer vessel is configured to transfer heat from the solid heat transfer medium to the feed stream, thereby cooling the solid heat transfer medium and heating the feed stream to the preheat temperature; and
the second heat transfer vessel is configured to receive the cooled solid heat transfer medium from the first heat transfer vessel.

14. The system of claim 11, wherein:
a first solid heat transfer medium is disposed within the first heat transfer vessel;
a second solid heat transfer medium is disposed within the second heat transfer vessel;
the first heat transfer vessel is configured to transfer heat from the first solid heat transfer medium to the feed stream, thereby cooling the first solid heat transfer medium and heating the feed stream to the preheat temperature; and
the second heat transfer vessel is configured to transfer heat from the mixed product stream to the second solid heat transfer medium, thereby heating the second solid heat transfer medium and cooling the mixed product stream to the specified temperature.

15. The system of claim 14, comprising a flow subsystem comprising:
a feed inlet flowline connected to the first heat transfer vessel and the second heat transfer vessel;
a feed outlet flowline connected to the first heat transfer vessel, the second heat transfer vessel, and the catalytic reactor; and
a mixed product inlet flowline connected to the first heat transfer vessel, the second heat transfer vessel, and the catalytic reactor.

16. The system of claim 15, wherein the flow subsystem is configured to, in a first flow configuration:
flow the feed stream through the first heat transfer vessel via the feed inlet flowline, thereby bringing the feed stream in contact with the first solid heat transfer medium and heating the feed stream, while preventing the feed stream from flowing to the second heat transfer vessel via the feed inlet flowline;
flow the feed stream from the first heat transfer vessel to the catalytic reactor via the feed outlet flowline; and
flow the mixed product stream from the catalytic reactor through the second heat transfer vessel via the mixed product inlet flowline, thereby bringing the mixed product stream in contact with the second solid heat transfer medium and cooling the mixed product stream, while preventing the mixed product stream from flowing to the first heat transfer vessel via the mixed product inlet flowline.

17. The system of claim 16, wherein the flow subsystem is configured to, in a second flow configuration:
flow the feed stream through the second heat transfer vessel via the feed inlet flowline, thereby bringing the feed stream in contact with the second solid heat transfer medium and heating the feed stream, while preventing the feed stream from flowing to the first heat transfer vessel via the feed inlet flowline;
flow the feed stream from the second heat transfer vessel to the catalytic reactor via the feed outlet flowline; and
flow the mixed product stream from the catalytic reactor through the first heat transfer vessel via the mixed product inlet flowline, thereby bringing the mixed product stream in contact with the first solid heat transfer medium and cooling the mixed product stream, while preventing the mixed product stream from flowing from the catalytic reactor to the second heat transfer vessel via the mixed product inlet flowline.

18. The system of claim 11, wherein the second heat transfer vessel is configured to mix the mixed product stream with water or liquefied sulfur to cool the mixed product stream to the specified temperature.

19. The system of claim 18, wherein the second heat transfer vessel is configured to condense at least a portion of the sulfur of the mixed product stream, wherein the second heat transfer vessel is configured to separate a sulfur stream comprising at least a portion of the sulfur that has condensed, wherein the second heat transfer vessel is configured to separate a hydrogen stream comprising the hydrogen from the mixed product stream.

20. The system of claim 19, comprising a water treatment unit downstream of the second heat transfer vessel, wherein the sulfur stream comprises the water, wherein the water treatment unit is configured to separate the water from the sulfur stream, wherein the water treatment unit is configured to recycle the separated water to the second heat transfer vessel.
